(19) United States
(12) Patent Application Publication
(10) Pub. No.: US 2022/0100926 A1
(43) Pub. Date: Mar. 31, 2022

(54) METHOD FOR CONSTRUCTING A FREE TRAJECTORY OF A BALLISTIC MISSILE AT A SPECIFIED LAUNCH ANGLE

(71) Applicant: Purple Mountain Observatory, Chinese Academy of Sciences, Nanjing (CN)

(72) Inventors: Jin XU, Nanjing (CN); Jianbo MA, Nanjing (CN); Jianli DU, Nanjing (CN); Zhibin CAO, Nanjing (CN); Dong YANG, Nanjing (CN)

(73) Assignee: Purple Mountain Observatory, Chinese Academy of Sciences, Nanjing (CN)

(21) Appl. No.: 17/435,405

(22) PCT Filed: Jul. 16, 2020
(86) PCT No.: PCT/CN2020/102341

§ 371 Date: Sep. 1, 2021

(30) Foreign Application Priority Data
Sep. 30, 2019 (CN) 201910941400.5

(51) Int. Cl. G06F 30/20; G06F 119/14; G06F 111/10

(52) U.S. Cl. CPC G06F 30/20; G06F 2111/10; G06F 2119/14

(57) ABSTRACT

A method for constructing a free trajectory of a ballistic missile at a specified launch angle includes: setting of an initial state of iterations: based on geodetic coordinates of a launch point and a target point, a launch epoch and the specified launch angle, assuming that the earth does not rotate and a flight time is zero; generating a new flight time in a two-body force model by using known quantities and obtained auxiliary quantities; taking a difference between flight times obtained before and after the iterations as a condition for judging convergence; outputting designed parameters of the ballistic missile after the convergence is reached, or performing a differential correction including the J2 perturbation to improve the precision of the trajectory constructed, and taking a position error of the target point as a convergence condition of the differential correction.

### CROSS REFERENCE TO THE RELATED APPLICATIONS

This application is the national phase entry of International Application No. PCT/CN2020/102341, filed on Jul. 16, 2020, which is based upon and claims priority to Chinese Patent Application No. 201910941400.5, filed on Sep. 30, 2019, the entire contents of which are incorporated herein by reference.

### TECHNICAL FIELD

The present invention pertains to the technical field of ballistic missile trajectory construction in celestial mechanics, and more particularly, relates to a method for constructing a free trajectory of a ballistic missile at a specified launch angle.

### BACKGROUND

The construction of trajectories for ballistic missiles is a prerequisite for ballistic research and data design. A complete ballistic trajectory includes a powered flight phase, a free flight phase and a reentry phase. The construction of a complete ballistic trajectory is typically accomplished based on specific performance parameters of the ballistic missile, involving some indefinite technical parameters and physical conditions that are complicated and time-consuming to compute, which cannot meet the requirements of general ballistic trajectory research and application. The free flight phase constitutes most of the flight time in the ballistic trajectory and involves a simple force analysis that mainly relates to the gravity of the earth exerted at the center of mass of the missile, in which phase the associated dynamic equations of motion of the missile are easy to solve and analyze. Hence, the development of a fast and effective method for constructing the free flight phase of a ballistic trajectory has important implications for providing a general trajectory simulation environment in the laboratory and aiding the design of ballistic data.

A trajectory constructed by taking the powered flight phase or the reentry phase or both of them as an extension of the free flight phase is referred to as a free trajectory. Article 1 (Bai Hefeng, Wu Ruilin, method for constructing trajectory of TBM [J], Modern Defense Technology, 1998(1):39-43.) proposes a method for constructing a free trajectory considering earth's rotation based on a minimum-energy trajectory theory, which is referred to as Method 1 hereinafter. Article 2 and Article 3 published later adopt the same construction method as Method 1. Specifically, Article 2 (Gu Tiejun, Liu Jian, Nie Cheng, Generation of TBM's Trajectory in the Simulation of Anti-TBM Battle [J], Modern Defense Technology, 2001(4).) corrects the reentry phase of an elliptical ballistic trajectory. Article 3 (Zhang Feng, Tian Kangsheng, Study on Construction of Trajectory for Ballistic Missile Early Warning Simulation System [J], Fire Control & Command Control, 2012, 37(3):94-98.) validates a constructed trajectory via Satellite Tool Kit (STK) software. The latter two methods also focus on the construction of free trajectories based on the minimum-energy theory.

In practice, the ballistic construction and data design must consider a combination of factors, typically focusing on not only the minimum energy as a crucial parameter, but also on other factors, such as the penetration effect of the missile on the impact velocity and the ground track of the trajectory to avoid certain deployment or sensitive areas. To comprehensively consider all factors, it is highly desirable to provide a more universal method for trajectory construction to produce alternative trajectories that are to be optimized and utilized according to specific needs in practice. Obviously, Method 1 does not meet such needs. Moreover, Method 1 has poor construction precision as it assumes that the earth is a homogeneous sphere and both the launch point and the target point are located on the surface of the sphere such that the missile is only subjected to the central gravity of the earth, and the launch point and the target point have equal geocentric radius vector moduli. Such a simplified model will cause a deviation in the impact point of the missile in terms of geometry and dynamics. This deviation increases with the range and the modulus difference between the true geocentric radius vectors of the launch point and the target point, even reaching up to tens of kilometers with regard to an intercontinental missile. In a case where the deviation of the impact point of the missile is required to be controlled on the order of hundreds of meters, consideration must be given to the oblateness of the earth while taking into account the major zonal harmonics perturbation, that is J₂ perturbation, of the earth's gravitational field in the dynamic model. Method 1, however, neither considers the effect of the perturbation nor the unequal geocentric radius vector moduli of the launch point and the target point, and thus fails to meet the requirements for high-precision trajectory construction.

### SUMMARY

An objective of the present invention is to provide a method for constructing a free trajectory of a ballistic missile at a specified launch angle. The method is capable of constructing a positive-flying trajectory and a negative-flying trajectory at a specified launch angle in a two-body force model and a dynamic model including the J2 perturbation of the earth's gravitational field, respectively, to derive all trajectories from a launch point to a target point by traversing the launch angle, thereby providing a wealth of alternative trajectories for general ballistic research, data design, and various application scenarios.

To achieve the objective of the present invention, the present invention adopts the following technical solutions. A method for constructing a free trajectory of a ballistic missile at a specified launch angle includes the following steps:

step 1: data preprocessing: sequentially computing a body-fixed rectangular coordinate vector \vec{R}_{A} of a launch point A and a body-fixed rectangular coordinate vector \vec{R}_{B} of a target point B, a difference Δφ between a geodetic latitude and a geocentric latitude of the launch point A, a horizontal angle ϕ between an AB direction and a north-pole direction of the launch point A in a body-fixed coordinate system, and a difference ε between a ratio of a modulus of the geocentric radius vector of the launch point A to a modulus of the geocentric radius vector of the target point B and 1;

step 2: setting of an initial state of iterations: assuming that the earth does not rotate and a flight time T is zero;

step 3: computing, in a two-body force model, a launch velocity vector \vec{\dot{r}}_{A} of a positive-flying trajectory or a negative-flying trajectory in a True Equator Mean Equinox of Epoch (TEMEE) coordinate system and a launch velocity vector \vec{\dot{R}}_{A} of the positive-flying trajectory or the negative-flying trajectory in the body-fixed coordinate system, a first type of non-singular orbital elements σ of the ballistic missile at a launch epoch, and a plurality of other variables to generate a new flight time T*; and

step 4: letting T=T*, repeating step 3 to iteratively compute the launch velocity vector \vec{\dot{r}}_{A} and the launch velocity vector \vec{\dot{R}}_{A} of the ballistic missile, the first type of non-singular orbital elements of the ballistic missile at the launch epoch, a half-range angle and the flight time until |T−T*| is less than a set threshold Sₜ to complete the iterations to finally obtain the launch velocity vector \vec{\dot{R}}_{A} and the flight time T of the ballistic missile in the two-body force model, and outputting designed parameters vₚ, vᵣ, Ã, T, σ.

Compared with the prior art, the present invention has the following significant advantages. Taking the rotation of the earth into account, the present invention combines the three-dimensional (3D) geodetic coordinates of the launch point and the target point to precisely construct a free trajectory from the launch point to the target point based on a constraint on the launch angle. The advantages of the present invention include: (1) When the launch angle, the launch epoch, and the geodetic coordinates of the launch point and the target point are specified, the method is capable of constructing a free trajectory from the launch point to the target point by using a two-body force model when the rotation of the earth is considered. (2) When the launch angle, the launch epoch, and the geodetic coordinates of the launch point and the target point are specified, the method is capable of constructing a free trajectory from the launch point to the target point under the rotation of the earth by using a dynamic model that takes into account a combination of the gravity at the center of the earth and the J₂ perturbation. (3) When the launch angle, the launch epoch and the geodetic coordinates of the launch point and the target point are specified, the method is capable of constructing not only a positive-flying trajectory but also a negative-flying trajectory from the target point to the launch point based on the premise of a rational launch angle. (4) Theoretically, the method is capable of constructing all free trajectories from the launch point to the target point by traversing the launch angle and specifying the positive-flying or negative-flying direction of the trajectories, thereby providing a wealth of complete alternative trajectories for various ballistic research, data design and application. (5) In the method, the launch point and the target point can be flexibly selected, where the launch point may be set as a conventional launch point or an orbit injection point, and the target point may be similarly set as a reentry point. (6) The method eliminates singularities in mathematics without special requirements on the coordinates of the launch point, such that the method is still applicable to the case where the launch point is selected to be located at the north or south pole or adjacent regions. (7) The method introduces special computation techniques. For example, the method employs the Bulirsch-Stoer (BS) rational polynomial extrapolation integration technique to compute the trajectories when the effect of the J₂ perturbation of the earth is taken into account, such that the method is suitable for the computation of highly-eccentric orbits, thereby ensuring the reliability and efficiency of the computed result in extreme cases. (8) The method is capable of constructing all free trajectories from the launch point to the target point by means of traversing, including not only the classic minimum-energy trajectory (with the smallest launch velocity in inertial space) but also the practical minimum-energy trajectory (with the smallest launch velocity in the body-fixed coordinate system). (9) The method is capable of outputting various designed parameters of the missile for a comprehensive and precise characterization of the free trajectory constructed, including not only the magnitude (relative to the inertial space and the ground) and direction (the azimuth of the velocity in the horizontal plane at the launch point) of the velocity at the launch point, and the flight time of the missile, but also six orbital elements of the missile relative to the TEMEE coordinate system at the launch epoch.

The present invention will be further explained in detail below with reference to the drawings.

### BRIEF DESCRIPTION OF DRAWINGS

FIG. 1 illustrates a positive-flying ballistic missile.

FIG. 2 illustrates a negative-flying ballistic missile.

FIG. 3 illustrates the launch angle h which is the intersection angle between the missile's velocity vector and the horizontal plane of the launch point A, where the horizontal plane may be replaced by the tangent plane of the reference ellipsoid in practice.

FIG. 4 illustrates a flowchart of the proposed method for constructing a free trajectory at a specified angle.

FIG. 5 illustrates the definition of the pseudo body-fixed coordinate at launch epoch t₀.

FIG. 6 illustrates the definition of the TEMEE coordinate system at epoch t, in which γ and Ŷ indicate the true equinox and the mean equinox, respectively.

FIG. 7 illustrates the definition of the conventional horizontal coordinate system XYZ and the target-pointing horizontal coordinate system X*Y*Z*.

FIG. 8 illustrates a sketch of the celestial sphere and the triangle formed by points P, Z_{A}, and Z_{B}.

FIG. 9 illustrates spherical triangles KAA′ and KBB′ formed by the earth equator, missile trajectory and meridians.

FIG. 10A and FIG. 10B illustrate spherical triangles formed by the velocity vector, zenith and geocentric radius vector of the launch point A in the Northern hemisphere and in the Southern hemisphere, respectively.

FIG. 11 illustrates the launch velocity vector, the zenith vector and the geocentric radius vector of the launch point A.

FIG. 12 illustrates the positive-flying free trajectories (left) and the negative-flying free trajectories (right) constructed by traversing the launch angle when using the two-body force model according to Embodiment 1.

FIG. 13 a graph illustrating the function between the launch angle and the launch velocity of the positive-flying trajectories constructed by traversing based on the two-body force model.

FIG. 14 a graph illustrating the function between the launch angle and the launch velocity of the negative-flying trajectories constructed by traversing based on the two-body force model.

FIG. 15 illustrates the ground track of the minimum-energy missile trajectory constructed by the two-body force model according to Embodiment 1.

FIG. 16 illustrates the positive-flying free trajectories constructed by traversing the launch angle when using the two-body force model according to Embodiment 2.

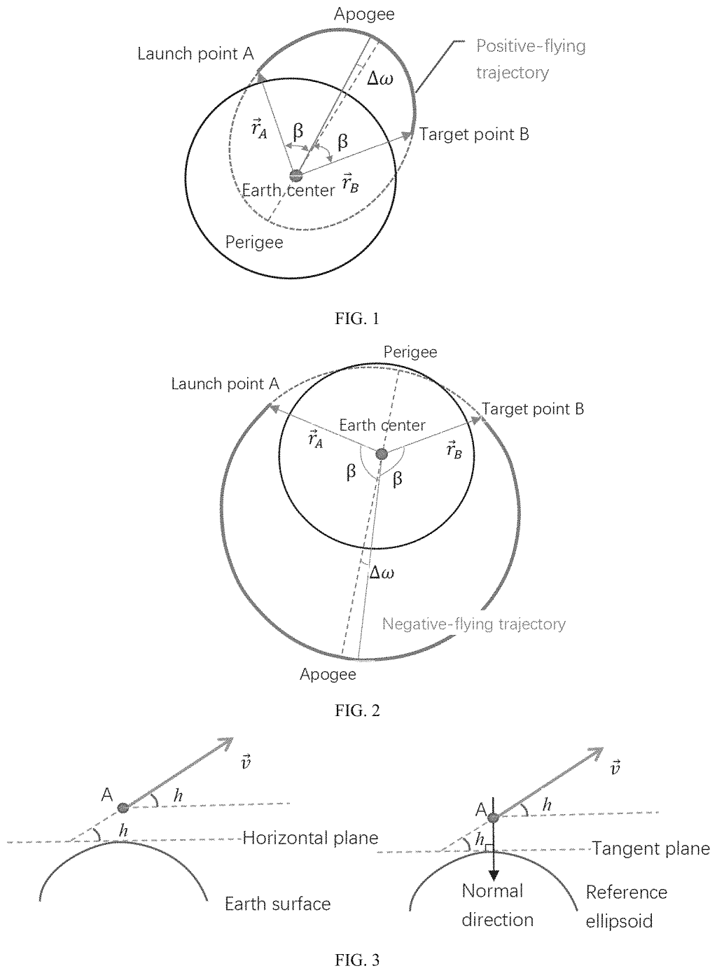

### DETAILED DESCRIPTION OF THE EMBODIMENTS

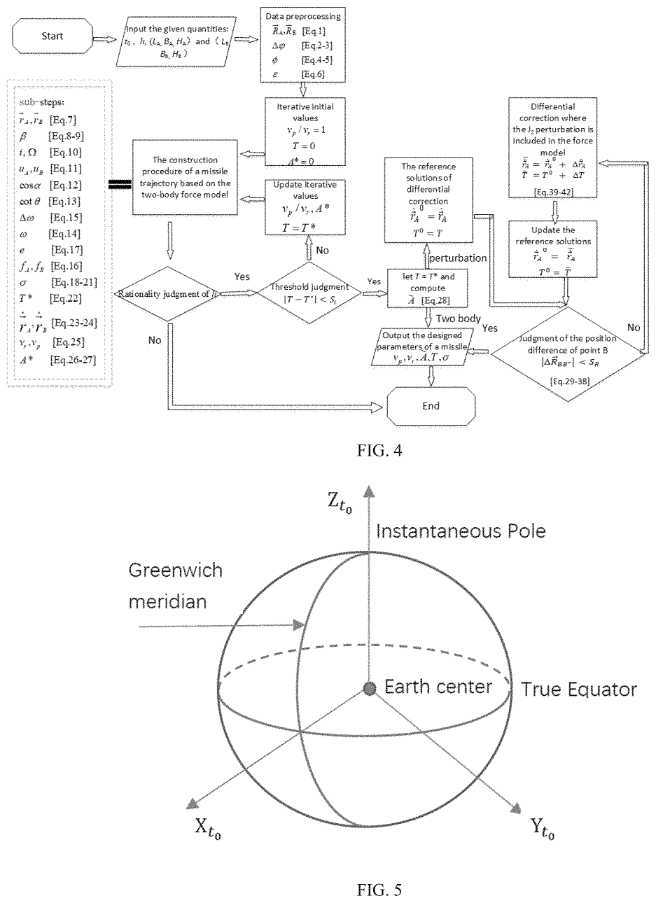

According to the present invention, referring to FIG. 4, a method for constructing a free trajectory of a ballistic missile at a specified launch angle specifically includes the following steps:

Step 1: data preprocessing: a body-fixed rectangular coordinate vector \vec{R}_{A} of the launch point A and a body-fixed rectangular coordinate vector \vec{R}_{B} of the target point B, a difference Δ_{φ} between the geodetic latitude and the geocentric latitude of the launch point A, a horizontal angle ϕ between the AB direction and the north-pole direction of the launch point (when the point A is not at or above the north or south pole) and a difference ε between a ratio of the modulus of the geocentric radius vector of the point A to the modulus of the geocentric radius vector of the point B and 1 are sequentially computed by specific steps as follows.

1. The geodetic coordinates of the points A and B are transformed from spherical coordinates (L, B, H) to three-dimensional (3D) rectangular coordinates (X, Y, Z) according to equation (1), and the 3D rectangular coordinates are expressed by \vec{R}_{A} and \vec{R}_{B} as follows:

$$\{ \begin{matrix}X = ( N + H ) cos B cos L \\ Y = ( N + H ) cos B sin L \\ Z = [ N ( 1 - {e}_{c}^{2} ) + H ] sin B\end{matrix} ; \qquad equation ( 1 )$$

wherein, N is the radius of curvature of the prime vertical of a point, and N=αₑ/\sqrt{1−e_{c}²(sin B)²}.

2. The geocentric latitudes φ_{A} and φ_{B} of the points A and B are computed according to equation (2):

$$φ = {sin}^{- 1} \frac{Z}{\sqrt{{X}^{2} + {Y}^{2} + {Z}^{2}}} . \qquad equation ( 2 )$$

3. The difference Δ_{φ} between the geodetic latitude and the geocentric latitude of the point A is computed according to equation (3):

$$Δφ = {B}_{A} - {φ}_{A} . \qquad equation ( 3 )$$

4. The horizontal angle ϕ between the AB direction and the north-pole direction of the launch point in the body-fixed coordinate system is computed according to a system of equations (4) and (5):

$$\{ \begin{matrix}sin ϕ = \frac{cos {B}_{B} sin ( {L}_{A} - {L}_{B} )}{sin q} \\ cos ϕ = \frac{sin {B}_{B} cos {B}_{A} - cos {B}_{B} sin {B}_{A} cos ( {L}_{A} - {L}_{B} )}{sin q}\end{matrix} ; \qquad equation ( 4 )$$

wherein, q is the zenith angle of the point B from the zenith of the point A and is computed by:

$$\{ \begin{matrix}cos q = sin {B}_{B} sin {B}_{A} + cos {B}_{B} cos {B}_{A} cos ( {L}_{A} - {L}_{B} ) \\ sin q = \sqrt{1 - {cos}^{2} q}\end{matrix} q ∈ ( 0 , π ) ; \qquad equation ( 5 )$$

in a particular case where the point A is located at or above the north or south pole, equations (4) and (5) are still satisfied, and are simplified as:

$$\{ \begin{matrix}ϕ = π - ( {L}_{A} - {L}_{B} ) & A is at or above the north pole \\ ϕ = {L}_{A} - {L}_{B} & A is at or above the south pole\end{matrix} \\ ∀ {L}_{A} ∈ [ 0 , 360 ° ) .$$

5. The difference ε between a ratio of the modulus of the geocentric radius vector of the point A to the modulus of the geocentric radius vector of the point B and 1 is computed according to equation (6):

$$ɛ = \frac{\vert {\vec{R}}_{B} \vert}{\vert {\vec{R}}_{A} \vert} - 1 . \qquad equation ( 6 )$$

Step 2: setting of the initial state of iterations: assuming that the earth does not rotate and the flight time T is zero.

If the earth does not rotate, the modulus vₚ of the launch velocity vector of the missile in the body-fixed coordinate system is equal to the modulus vᵣ of the launch velocity vector in the TEMEE coordinate system, that is,

$$\frac{{v}_{p}}{{v}_{r}} = 1 .$$

Meanwhile, the launch azimuth A* in the target-pointing horizontal coordinate system is zero.

Step 3: the launch velocity vector \vec{\dot{r}}_{A} of the positive-flying trajectory or the negative-flying trajectory in the TEMEE coordinate system and the launch velocity vector \vec{\dot{R}}_{A} of the positive-flying trajectory or the negative-flying trajectory in the body-fixed coordinate system, the first type of non-singular orbital elements a of the missile at the launch epoch, the flight time, and a plurality of other variables are computed in the two-body force model to generate a new flight time T* specifically by the following steps.

1. The coordinate vectors \vec{r}_{A} and \vec{r}_{B} of the points A and B in the TEMEE coordinate system are computed in combination with the flight time T according to equation (7):

$$\{ \begin{matrix}{\vec{r}}_{A} = M ( {t}_{0} ) {\vec{R}}_{A} \\ {\vec{r}}_{B} = M ( {t}_{0} + T ) {\vec{R}}_{B}\end{matrix} ; \qquad equation ( 7 )$$

wherein, t₀ is the launch epoch, and M is a time-dependent transformation matrix from the body-fixed coordinate system to the TEMEE coordinate system. In a first iteration, the flight time T is zero, and \vec{r}_{B}=M(t₀)\vec{R}_{B} is satisfied.

2. The half-range angle is computed according to equations (8) and (9) as follows:

a half intersection angle is expressed by:

$$δ = \frac{1}{2} \times {cos}^{- 1} \frac{{\vec{r}}_{A} \cdot {\vec{r}}_{B}}{\vert {\vec{r}}_{A} \vert \vert {\vec{r}}_{B} \vert} ; \qquad equation ( 8 )$$

then the half-range angle is computed by:

$$β = \{ \begin{matrix}δ & β ∈ ( 0 , \frac{π}{2} ) & positive - flying trajectory \\ π - δ & β ∈ ( \frac{π}{2} , π ) & negative - flying trajectory\end{matrix} . \qquad equation ( 9 )$$

3. An inclination i and a right ascension Ω of an ascending node of an elliptical trajectory/orbit are computed according to equation (10):

$$\{ \begin{matrix}[ \begin{matrix}sin i sin Ω \\ - sin i cos Ω \\ cos i\end{matrix} ] = \frac{{\vec{r}}_{A} \times {\vec{r}}_{B}}{\vert {\vec{r}}_{A} \times {\vec{r}}_{B} \vert} & positive - flying trajectory \\ [ \begin{matrix}sin i sin Ω \\ - sin i cos Ω \\ cos i\end{matrix} ] = \frac{{\vec{r}}_{B} \times {\vec{r}}_{A}}{\vert {\vec{r}}_{B} \times {\vec{r}}_{A} \vert} & negative - flying trajectory\end{matrix} \\ i ∈ ( 0 , π ) Ω ∈ [ 0 , 2 π ) . \qquad equation ( 10 )$$

4. True arguments of latitude μ_{A} and μ_{B} of the points A and B on the elliptical trajectory/orbit are computed according to equation (11):

$$\{ \begin{matrix}sin {u}_{A} = \frac{sin {φ}_{A}}{sin i} \\ cos {u}_{A} = \frac{sin {φ}_{B} - sin {φ}_{A} cos 2 β}{sin i sin 2 β} \\ {u}_{B} = {u}_{A} + 2 β\end{matrix} . \qquad equation ( 11 )$$

5. The cosine of an angle α between the launch velocity vector and the geocentric radius vector of the launch point in the body-fixed coordinate system is computed according to equation (12):

$$cos α = cos Δφsin h - sin Δφcos h cos ( {A}^{*} - ϕ ) ; \qquad equation ( 12 )$$

wherein, h is the launch angle, and A*=0 in the first iteration.

6. The tangent of an angle θ between the launch velocity vector and the geocentric radius vector of the launch point in the TEMEE coordinate system is computed according to equation (13):

$$\{ \begin{matrix}cos θ = \frac{{v}_{P}}{{v}_{r}} cos α \\ sin θ = \sqrt{1 - {cos}^{2} θ} \\ cot θ = \frac{cos θ}{sin θ}\end{matrix} ; \qquad equation ( 13 )$$

wherein,

$$\frac{{v}_{P}}{{v}_{r}} = 1$$

in the first iteration.

7. A bias Δω of the argument of perigee is introduced and computed according to equation (15), and then the argument of perigee ω is computed according to equation (14).

According to the nature of the elliptical trajectory/orbit of a ballistic missile, the apogee of the trajectory is located in an outer space of the earth and between the points A and B. When the geocentric radius vector moduli of the points A and B are equal, the argument of apogee is equal to the mean value of the true arguments of latitude of the points A and B and then the mean value minus π obtains the argument of perigee ω. The argument of perigee ω computed in this way, however, generally has a deviation due to unequal geocentric distances of the point A and the point B. The bias Δω of ω is introduced to obtain:

$$ω = {ω}_{0} + Δω ω ∈ [ 0 , 2 π ) ; \qquad equation ( 14 )$$

wherein,

$${ω}_{0} = \frac{{u}_{A} + {u}_{B}}{2} - π ,$$

wherein μ_{A} and μ_{B} have been computed according to equation (11); Δω is computed according to equation (15):

$$tan Δ ω = \frac{ɛ}{2 ( 1 + ɛ ) cot θ - ɛ cot β} Δω ∈ [ - \frac{π}{2} , \frac{π}{2} ] \qquad equation ( 15 )$$

accordingly, true anomalies of the points A and B on the elliptical trajectory/orbit are expressed by Δω as follows:

$$\{ \begin{matrix}{f}_{A} = π - β - Δ ω \\ {f}_{B} = π + β - Δ ω\end{matrix} . \qquad equation ( 16 )$$

8. An eccentricity e of the elliptical trajectory/orbit is computed according to equation (17):

$$e = \frac{cot θ}{sin ( β + Δ ω ) + cot θ cos ( β + Δ ω )} . \qquad equation ( 17 )$$

9. The rationality of the specified launch angle h is judged as follows. If any one of the following conditions is satisfied, then the specified launch angle is judged to be irrational such that a rationally designed trajectory cannot be obtained, the current construction procedure of the trajectory is ended, and a launch angle is re-specified.

For the positive-flying trajectory:

(1) If e≥1, then the specified launch angle is judged to be excessively large; and

(2) If cot θ≤0 or |tan Δω|≥tan β, then the specified launch angle is judged to be excessively small.

For the negative-flying trajectory:

$$If e \geq 1 or cot θ \geq - tan β + \frac{ɛ}{2 ( 1 + ɛ )} ( tan β + cot β ) , \qquad ( 1 )$$

then the specified launch angle is judged to be excessively large; and

$$if cot θ \leq max \{ \frac{ɛ}{2 ( 1 + ɛ )} cot β , 0 \} , \qquad ( 2 )$$

then the specified launch angle is judged to be excessively small.

10. The true anomalies f_{A} and f_{B} of the points A and B on the elliptical trajectory/orbit are computed according to equation (16).

11. The orbital elements σ of the missile at the launch epoch are computed according to equations (18) to (21).

σ is a set of the first type of non-singular orbital elements, wherein the inclination i and the right ascension Ω of the ascending node of the orbit are computed according to equation (10), and a semi-major axis α and ξ, η, λ are computed as follows:

$$\begin{matrix}a = \frac{\vert {\vec{r}}_{A} \vert [ 1 - e cos ( β + Δω ) ]}{1 - {e}^{2}} ; & equation ( 18 ) \\ \{ \begin{matrix}ζ = e cos ω \\ η = - e sin ω \\ λ = ω + {M}_{A}\end{matrix} ; & equation ( 19 )\end{matrix}$$

wherein M_{A} is computed as follows:

$$\begin{matrix}\{ \begin{matrix}{E}_{A} = {f}_{A} - 2 {tan}^{- 1} ( \frac{e sin {f}_{A}}{1 + \sqrt{1 - {e}^{2}} + e cos {f}_{A}} ) \\ {E}_{B} = {f}_{B} - 2 {tan}^{- 1} ( \frac{e sin {f}_{B}}{1 + \sqrt{1 - {e}^{2}} + e cos {f}_{B}} )\end{matrix} ; & equation ( 20 ) \\ \{ \begin{matrix}{M}_{A} = {E}_{A} - e sin {E}_{A} \\ {M}_{B} = {E}_{B} - e sin {E}_{B}\end{matrix} . & equation ( 21 )\end{matrix}$$

12. The flight time T* of the missile is computed according to equation (22):

$$\{ \begin{matrix}{T}^{*} = \frac{{M}_{B} - {M}_{A}}{n} \\ n = \sqrt{μ / {a}^{3}}\end{matrix} . \qquad equation ( 22 )$$

13. The launch velocity vᵣ of the missile in the TEMEE coordinate system and the launch velocity vₚ of the missile in the body-fixed coordinate system are computed according to equations (23) to (25) as follows:

the launch velocity vectors \vec{\dot{r}}_{A} and \vec{\dot{R}}_{A} of the missile in the TEMEE coordinate system and the body-fixed coordinate system satisfy:

$$\begin{matrix}\{ \begin{matrix}{\dot{\vec{r}}}_{A} = \sqrt{\frac{μ}{ρ}} [ ( - sin {u}_{A} + η ) \vec{P} + ( cos {u}_{A} + ξ ) \vec{Q} ] \\ \vec{P} = [ \begin{matrix}cos Ω \\ sin Ω \\ 0\end{matrix} ] \\ \vec{Q} = [ \begin{matrix}- sin Ω cos i \\ cos Ω cos i \\ sin i\end{matrix} ] \\ p = a ( 1 - {e}^{2} )\end{matrix} ; & equation ( 23 ) \\ {\dot{\vec{R}}}_{A} = M ( {t}_{0} ) {\dot{\vec{r}}}_{A} - {\dot{θ}}_{g} [ \begin{matrix}- {Y}_{A} \\ {X}_{A} \\ 0\end{matrix} ] ; & equation ( 24 ) \\ then : & \\ \{ \begin{matrix}{v}_{p} = \vert {\dot{\vec{R}}}_{A} \vert \\ {v}_{r} = \vert {\dot{\vec{r}}}_{A} \vert\end{matrix} ; & equation ( 25 )\end{matrix}$$

wherein, \dot{θ}_{g} is a change rate of the Greenwich sidereal hour angle in the TEMEE coordinate system and is 360°.985612288/day.

14. The launch azimuth A* in the target-pointing horizontal coordinate system is computed according to equations (26) and (27):

the launch velocity vector in the target-pointing horizontal coordinate system is denoted as \vec{\dot{R}}_{A*}(X*,Y*,Z*), which is derived by performing a coordinate rotation on \vec{\dot{R}}_{A} as follows:

$$\begin{matrix}{\dot{\vec{R}}}_{{A}^{*}} = QW {\dot{\vec{R}}}_{A} ; & equation ( 27 ) \\ [ \begin{matrix}{X}^{*} \\ {Y}^{*} \\ {Z}^{*}\end{matrix} ] = \vert {\dot{\vec{R}}}_{{A}^{*}} \vert [ \begin{matrix}cos h cos {A}^{*} \\ - cos h sin {A}^{*} \\ sin h\end{matrix} ] ; & equation ( 28 )\end{matrix}$$

wherein, W is a rotation matrix from the body-fixed coordinate system to the conventional horizontal coordinate system, and Q is a rotation matrix from the conventional horizontal coordinate system to the target-pointing horizontal coordinate system.

Step 4: let T=T*, step 3 is repeated to iteratively compute the launch velocity vector of the missile, the orbital elements of the missile at the launch epoch, the half-range angle, the flight time and a plurality of other variables until |T−T*| is less than a set threshold Sₜ to complete the iterations to finally obtain the launch velocity vector \vec{\dot{r}}_{A} and the flight time T of the missile in the two-body force model, and designed parameters vₚ, vᵣ, Ã, T, σ of the missile are output. The specific steps thereof include:

1. It is judged whether |T−T*|<Sₜ is satisfied; if yes, let T=T*, and proceeding to the next step; otherwise, let T=T*, and returning to step 3.

2. A declination Ã of the launch velocity vector in the target-pointing horizontal coordinate system relative to the target point in the horizontal plane is computed according to equation (28):

$$\{ \begin{matrix}\tilde{A} = {A}^{*} & {A}^{*} \leq π \\ \tilde{A} = {A}^{*} - 2 π & {A}^{*} > π\end{matrix} . \qquad equation ( 28 )$$

3. The designed parameters vₚ, vᵣ, Ã, T, σ of the missile are output.

Through steps 1 to 4, the designed parameters of the missile from the launch point to the target point are derived based on the two-body force model to support various simulation applications and trajectory construction that requires a lower precision. In a case where the trajectory construction requires higher precision and the J₂ perturbation of the earth's gravitational field needs to be considered, the results obtained in the two-body force model are taken as initial values to establish a constraint equation with a constant launch angle and a differential equation based on a position error propagation of the target point for a differential correction. The specific implementation thereof includes steps 5 and 6.

Step 5: the launch velocity vector \vec{\dot{r}}_{A} and the flight time T obtained by the two-body force model are taken as reference solutions \vec{\dot{r}}_{A}⁰ and T⁰ for the differential correction; if a distance |Δ\vec{R}_{BB*}| between the target point B and a target point B* obtained by a perturbation extrapolation based on the reference solutions is less than a given threshold S_{R}, then the correction of the designed parameters of the missile is ended, and corrected parameters vₚ, vᵣ, Ã, T, σ are output; otherwise, proceeding to step 6. In the iterative process, the thresholds are small quantities, where Sₜ may be 10 μs, and S_{R} may be 1 cm.

Step 5 includes the following sub-steps:

1. The target point obtained by the perturbation extrapolation based on the reference solutions \vec{\dot{r}}_{A}⁰ and T⁰ is denoted as B*, and partial derivative matrices

$$\frac{\partial {\vec{r}}_{{B}^{*}}}{\partial {\vec{r}}_{A}} , \frac{\partial {\vec{r}}_{{B}^{*}}}{\partial T}$$

and a position vector \vec{r}_{B*} of B* in the TEMEE coordinate system are computed by a numerical integration.

To adapt to computing highly-eccentric trajectories, the numerical integration is performed by a Gragg-Bulirsch-Stoer first-order integrator (Article 4: Bulirsch R, Stoer J. Numerical Treatment of Ordinary Differential Equations by Extrapolation Methods [J]. Numerische Mathematik, 1966, 8 (1):1-13.), where the differential equations to be integrated are:

$$\{ \begin{matrix}\frac{d \vec{r}}{dt} = \vec{v} \\ \frac{d \vec{v}}{d t} = \vec{F} ( \vec{r} ) \\ \frac{d}{dt} ( \frac{\partial \vec{r}}{\partial {\dot{\vec{r}}}_{A}} ) = \frac{\partial \vec{v}}{\partial {\dot{\vec{r}}}_{A}} \\ \frac{d}{dt} ( \frac{\partial \vec{v}}{\partial {\dot{\vec{r}}}_{A}} ) = \frac{\partial \vec{F}}{\partial \vec{r}} \cdot \frac{\partial \vec{r}}{\partial {\dot{\vec{r}}}_{A}}\end{matrix} ; \qquad equation ( 29 )$$

derive initial values as:

$$\{ \begin{matrix}\vec{r} ( {t}_{0} ) = {\vec{r}}_{A} \\ \vec{v} ( {t}_{0} ) = {\dot{\vec{r}}}_{A}^{0} \\ \frac{\partial \vec{r}}{\partial {\dot{\vec{r}}}_{A}} {\vert}_{t = {t}_{0}} = 0 \\ \frac{\partial \vec{v}}{\partial {\dot{\vec{r}}}_{A}} {\vert}_{t = {t}_{0}} = I\end{matrix} ; \qquad equation ( 30 )$$

integrate from t=t₀ to t=t₀+T⁰ to obtain:

$$\{ \begin{matrix}{\vec{r}}_{{B}^{*}} = \vec{r} {\vert}_{t = {t}_{0} + {T}^{0}} \\ \frac{\partial {\vec{r}}_{{B}^{*}}}{\partial T} = \vec{v} {\vert}_{t = {t}_{0} + {T}^{0}} \\ \frac{\partial {\vec{r}}_{{B}^{*}}}{\partial {\dot{\vec{r}}}_{A}} = \frac{\partial \vec{r}}{\partial {\dot{\vec{r}}}_{A}} {\vert}_{t = {t}_{0} + {T}^{0}}\end{matrix} ; \qquad equation ( 31 )$$

the force function \vec{F}(\vec{r}) only including the J2 perturbation and its partial derivative matrix

$$\frac{\partial \vec{F}}{\partial \vec{r}}$$

in equation (29) are expressed as:

$$\{ \begin{matrix}\vec{F} = {( ∇ U )}_{r} = M ( t ) \cdot {( ∇ U )}_{R} \\ \frac{\partial \vec{F}}{\partial \vec{r}} = {( {∇}^{2} U )}_{r} = M ( t ) \cdot {( {∇}^{2} U )}_{R} \cdot {M}^{T} ( t )\end{matrix} ; \qquad equation ( 32 )$$

wherein, t is an integration time; subscripts r and R represent a gradient or tensor of U in the TEMEE coordinate system and the body-fixed coordinate system, respectively; U represents a gravitational potential function of the earth in the body-fixed coordinate system and includes a central gravitational potential U₀ and a J₂ gravitational potential U₁:

$$U = {U}_{0} + {U}_{1} . \qquad equation ( 33 )$$

Accordingly, the gradient and tensor of the gravitational potential function U of the earth are obtained as follows:

$$\begin{matrix}\{ \begin{matrix}{( ∇ U )}_{R} = {( ∇ {U}_{0} )}_{R} + {( ∇ {U}_{1} )}_{R} \\ {( {∇}^{2} U )}_{R} = {( {∇}^{2} {U}_{0} )}_{R} + {( {∇}^{2} {U}_{1} )}_{R}\end{matrix} ; \\ wherein , & equation ( 34 ) \\ \{ \begin{matrix}{( ∇ {U}_{0} )}_{R} = - \frac{μ}{{r}^{3}} {( X , Y , Z )}^{T} \\ {( {∇}^{2} {U}_{0} )}_{R} = \frac{μ}{{r}^{3}} [ \begin{matrix}- 1 + 3 \frac{{X}^{2}}{{r}^{2}} & \frac{3 XY}{{r}^{2}} & \frac{3 XZ}{{r}^{2}} \\ \frac{3 XY}{{r}^{2}} & - 1 + 3 \frac{{Y}^{2}}{{r}^{2}} & \frac{3 YZ}{{r}^{2}} \\ \frac{3 XZ}{{r}^{2}} & \frac{3 YZ}{{r}^{2}} & 1 + 3 \frac{{Z}^{2}}{{r}^{2}}\end{matrix} ] \\ {( ∇ {U}_{1} )}_{R} = {( \frac{\partial {U}_{1}}{\partial X} , \frac{\partial {U}_{1}}{\partial Y} , \frac{\partial {U}_{1}}{\partial Z} )}^{T} \\ {( {∇}^{2} {U}_{1} )}_{R} = [ \begin{matrix}\frac{{\partial }^{2} {U}_{1}}{\partial {X}^{2}} & \frac{{\partial }^{2} {U}_{1}}{\partial X \partial Y} & \frac{{\partial }^{2} {U}_{1}}{\partial X \partial Z} \\ \frac{{\partial }^{2} {U}_{1}}{\partial X \partial X} & \frac{{\partial }^{2} {U}_{1}}{\partial {Y}^{2}} & \frac{{\partial }^{2} {U}_{1}}{\partial Y \partial Z} \\ \frac{{\partial }^{2} {U}_{1}}{\partial Z \partial X} & \frac{{\partial }^{2} {U}_{1}}{\partial Z \partial Y} & \frac{{\partial }^{2} {U}_{1}}{\partial {Z}^{2}}\end{matrix} ]\end{matrix} ; & equation ( 35 )\end{matrix}$$

wherein, (X, Y, Z)^{T} is a 3D rectangular coordinate vector of the missile in the body-fixed coordinate system, and r=R=\sqrt{X²+Y²+Z²}; with reference to Article 6 (Balmino G, Barriot J P, Valès N. Non-singular formulation of the gravity vector and gravity gradient tensor in spherical harmonics [J]. Manuscr Geod, 1990, 15.), the elements composing the above matrices or vectors are expressed by:

$$\{ \begin{matrix}let {θ}_{1} = \frac{X}{r} ; {θ}_{2} = \frac{Y}{r} ; {θ}_{3} = \frac{Z}{r} = ζ \\ {\overline{P}}_{2} ( ζ ) = \sqrt{5} \times \frac{( 3 {ζ}^{2} - 1 )}{2} ; {\overline{P}}_{2}^{!} ( ζ ) = 3 \sqrt{5} ζ ; {\overline{P}}_{2}^{″} ( ζ ) = 3 \sqrt{5} \\ {D}_{r} = - 3 {{\overline{C}}_{20} ( \frac{{a}_{e}}{r} )}^{2} {\overline{P}}_{2} ( ζ ) ; {D}_{3} = {{\overline{C}}_{20} ( \frac{{a}_{e}}{r} )}^{2} {\overline{P}}_{2}^{′} ( ζ ) \\ {S}_{r r} = 12 {{\overline{C}}_{20} ( \frac{{a}_{e}}{r} )}^{2} {\overline{P}}_{2} ( ζ ) ; {S}_{r 3} = - 3 {{\overline{C}}_{20} ( \frac{{a}_{e}}{r} )}^{2} {\overline{P}}_{2}^{′} ( ζ ) ; {S}_{33} = {{\overline{C}}_{20} ( \frac{{a}_{e}}{r} )}^{2} {\overline{P}}_{2}^{″} ( ζ ) \\ \tilde{ϕ} = {D}_{r} - {D}_{3} {θ}_{3} \\ \frac{\partial {U}_{1}}{\partial X} = \frac{μ}{{r}^{2}} \tilde{ϕ} {θ}_{1} ; \frac{\partial {U}_{1}}{\partial Y} = \frac{μ}{{r}^{2}} \tilde{ϕ} {θ}_{2} ; \frac{\partial {U}_{1}}{\partial Z} = \frac{μ}{{r}^{2}} ( {D}_{3} + \overline{ϕ} {θ}_{3} ) \\ \frac{{\partial }^{2} {U}_{1}}{\partial {X}^{2}} = \frac{μ}{{r}^{3}} \{ \tilde{ϕ} + [ {S}_{r r} + 2 ( {D}_{3} - {S}_{r 3} ) {θ}_{3} - \tilde{ϕ} + {S}_{33} {θ}_{3}^{2} ] {θ}_{1}^{2} \} \\ \frac{{\partial }^{2} {U}_{1}}{\partial X \partial Y} = \frac{μ}{{r}^{3}} [ {S}_{rr} + 2 ( {D}_{3} - {S}_{r 3} ) {θ}_{3} - \tilde{ϕ} + {S}_{33} {θ}_{3}^{2} ] {θ}_{1} {θ}_{2} \\ \frac{{\partial }^{2} {U}_{1}}{\partial X \partial Z} = \frac{μ}{{r}^{3}} \{ ( {S}_{r 3} - {D}_{3} - {S}_{33} {θ}_{3} ) {θ}_{1} + [ {S}_{r r} + 2 ( {D}_{3} - {S}_{r 3} ) {θ}_{3} - \tilde{ϕ} + {S}_{33} {θ}_{3}^{2} ] {θ}_{1} {θ}_{3} \} \\ \frac{{\partial }^{2} {U}_{1}}{\partial Y 2} = \frac{μ}{{r}^{3}} \{ \tilde{ϕ} + [ {S}_{r r} + 2 ( {D}_{3} - {S}_{r 3} ) {θ}_{3} - \tilde{ϕ} + {S}_{33} {θ}_{3}^{2} ] {θ}_{2}^{2} \} \\ \frac{{\partial }^{2} {U}_{1}}{\partial Y \partial Z} = \frac{μ}{{r}^{3}} \{ ( {S}_{r 3} - {D}_{3} - {S}_{33} {θ}_{3} ) {θ}_{2} + [ {S}_{r r} + 2 ( {D}_{3} - {S}_{r 3} ) {θ}_{3} - \tilde{ϕ} + {S}_{33} {θ}_{3}^{2} ] {θ}_{2} {θ}_{3} \} \\ \frac{{\partial }^{2} {U}_{1}}{\partial {Z}^{2}} = \frac{μ}{{r}^{3}} \{ \tilde{ϕ} + {S}_{33} + 2 ( {S}_{r 3} - {D}_{3} - {S}_{33} {θ}_{3} ) {θ}_{3} + [ {S}_{r r} + 2 ( {D}_{3} - {S}_{r 3} ) {θ}_{3} - \tilde{ϕ} + {S}_{33} {θ}_{3}^{2} ] {θ}_{3}^{2} \}\end{matrix} ; \qquad equation ( 36 )$$

wherein, C̅₂₀ is a normalized spherical harmonic coefficient corresponding to the J₂ perturbation in an expansion of a spherical harmonic series of the earth's gravitational potential.

2. A position vector difference Δ\vec{R}_{BB*} between the target point B and the target point B* obtained by the perturbation extrapolation based on the reference solutions and \vec{\dot{r}}_{A}⁰ and T⁰ in the body-fixed coordinate system are computed according to equations (37) and (38):

$$Δ {\vec{R}}_{{BB}^{*}} = {\vec{R}}_{B} - {\vec{R}}_{{B}^{*}} = [ \begin{matrix}{X}_{B} \\ {Y}_{B} \\ {Z}_{B}\end{matrix} ] - [ \begin{matrix}{X}_{{B}^{*}} \\ {Y}_{{B}^{*}} \\ {Z}_{{B}^{*}}\end{matrix} ] ; \qquad equation ( 37 )$$

wherein, a coordinate vector \vec{R}_{B*}(\vec{X}_{B*}, \vec{Y}_{B*}, \vec{Z}_{B*}) of B* in the body-fixed coordinate system is obtained from \vec{r}_{B*} through a coordinate transformation:

$${\vec{R}}_{{B}^{*}} = {M}^{T} ( {t}_{0} + {T}^{0} ) {\vec{r}}_{{B}^{*}} . \qquad equation ( 38 )$$

3. It is judged whether Δ\vec{R}_{BB*} is less than the given threshold S_{R}; if yes, the designed parameters vₚ, vᵣ, Ã, T, σ of the missile are recomputed and output based on the reference solutions and corresponding equations in steps 3 and 4, and the correction is ended; otherwise, proceeding to step 6 to perform a differential correction in order to estimate a launch velocity vector increment and a flight time increment.

Step 6: the constraint equation with the constant launch angle and a differential equation based on a position error propagation of the target point are established; the launch velocity vector increment Δ\vec{\dot{r}}_{A} and the flight time increment ΔT are computed, and corrected solutions are denoted as [symbol] and \hat{T}; the corrected solutions are taken as reference solutions for a next differential correction, that is, let: \vec{\dot{r}}_{A}⁰= [symbol] , T⁰=\hat{T}, and repeat the sub-steps of step 5.

Step 6 includes the following sub-steps:

1. A system of linear differential equations of the launch velocity vector increment Δ\vec{\dot{r}}_{A} and the flight time increment ΔT are established according to equations (39) to (41):

$$[ \begin{matrix}G & 0 \\ C & D\end{matrix} ] [ \begin{matrix}Δ {\dot{\vec{r}}}_{A} \\ Δ T\end{matrix} ] = [ \begin{matrix}0 \\ Δ {\vec{R}}_{{BB}^{*}}\end{matrix} ] ; \qquad equation ( 39 )$$

wherein, Δ\vec{\dot{r}}_{A}(Δ\vec{\dot{x}}_{A}, Δ\vec{\dot{y}}_{A}, Δ\vec{ż}_{A}) and Δ\vec{R}_{BB*}(Δ\vec{x}_{BB*}, Δ\vec{y}_{BB*}, Δ\vec{z}_{BB*}) are expressed in terms of components as:

$$[ \begin{matrix}G & 0 \\ C & D\end{matrix} ] [ \begin{matrix}Δ {\dot{\vec{x}}}_{A} \\ Δ {\dot{\vec{y}}}_{A} \\ Δ {\dot{\vec{z}}}_{A} \\ Δ T\end{matrix} ] = [ \begin{matrix}0 \\ Δ {\vec{x}}_{{BB}^{*}} \\ Δ {\vec{y}}_{{BB}^{*}} \\ Δ {\vec{z}}_{{BB}^{*}}\end{matrix} ] ; \qquad equation ( 40 )$$

wherein, G is a 1×3 matrix, C is a 3×3 matrix, D is a 3×1 matrix, which are expressed as:

$$\{ \begin{matrix}G = [ - sin h cos {A}^{*} sin h sin {A}^{*} cos h ] {QWM}^{T} ( {t}_{0} ) \\ C = {M}^{T} ( {t}_{0} + {T}^{0} ) \frac{\partial {\vec{r}}_{{B}^{*}}}{\partial {\dot{\vec{r}}}_{A}} \\ D = {M}^{T} ( {t}_{0} + {T}^{0} ) \frac{\partial {\vec{r}}_{{B}^{*}}}{\partial T} + {\dot{θ}}_{g} [ \begin{matrix}{Y}_{{B}^{*}} \\ - {X}_{{B}^{*}} \\ 0\end{matrix} ]\end{matrix} ; \qquad equation ( 41 )$$

wherein,

$$\frac{\partial {\vec{r}}_{B}}{\partial {\dot{\vec{r}}}_{A}} and \frac{\partial {\vec{r}}_{{B}^{*}}}{\partial T}$$

are computed by the numerical integration in step 5. The matrix G generates the constraint equation with the constant launch angle.

2. The system of linear differential equations are solved to obtain a set of unique solutions of Δ\vec{\dot{r}}_{A} and ΔT;

the system of linear equations (40) includes four equations and four unknown quantities so that a set of unique solutions of Δ\vec{\dot{r}}_{A} and ΔT are obtained, and then the corrected solutions [symbol] and \hat{T} are obtained according to equation (42):

$$\{ \begin{matrix}= {\dot{\vec{r}}}_{A}^{0} + Δ {\dot{\vec{r}}}_{A} \\ \hat{T} = {T}^{0} + Δ T\end{matrix} . \qquad equation ( 42 )$$

3. The corrected solutions are taken as the reference solutions for the next differential correction, that is, let \vec{\dot{r}}_{A}⁰= [symbol] , T⁰=\hat{T}, and repeat the sub-steps of step 5.

To facilitate the understanding of the technical solutions of the present invention, the technical solutions are described clearly and completely in conjunction with the embodiments below. The embodiments apply the variables and symbols defined in the technical solutions and derive corresponding results by assigning specific numerical values to the variables. The definitions of the coordinate systems and the transformation methods are first introduced below, and then the technical solutions are described in detail in conjunction with the embodiments.

I. Coordinate Systems and Transformation Matrices

1. Body-Fixed Coordinate System

The body-fixed coordinate system is an earth-fixed coordinate system that rotates with the earth. The body-fixed coordinate system can conveniently describe the spatial position of a point on the earth's surface, and is divided into a conventional body-fixed coordinate system and a pseudo body-fixed coordinate system according to different directions to which the Z-axis points. The difference (caused by polar motion) between the conventional body-fixed coordinate system and the pseudo body-fixed coordinate system has a minimal effect on the coordinates of the ground point. FIG. 5 illustrates the definition of the pseudo body-fixed coordinate system, in which the Z-axis points to the instantaneous pole, and the reference plane is an instantaneous equatorial plane. In the conventional body-fixed coordinate system, the Z-axis points to a conventional pole, and the reference plane is a plane orthogonal to a line connecting the center of the earth and the conventional pole. In consideration of the research background of the present invention, the difference between the conventional pole and the instantaneous pole can be ignored so that the conventional body-fixed coordinate system and the pseudo body-fixed coordinate system are collectively referred to as the body-fixed coordinate system (or geodetic coordinate system) in two forms of spherical coordinates and 3D rectangular coordinates.

2. TEMEE Coordinate System

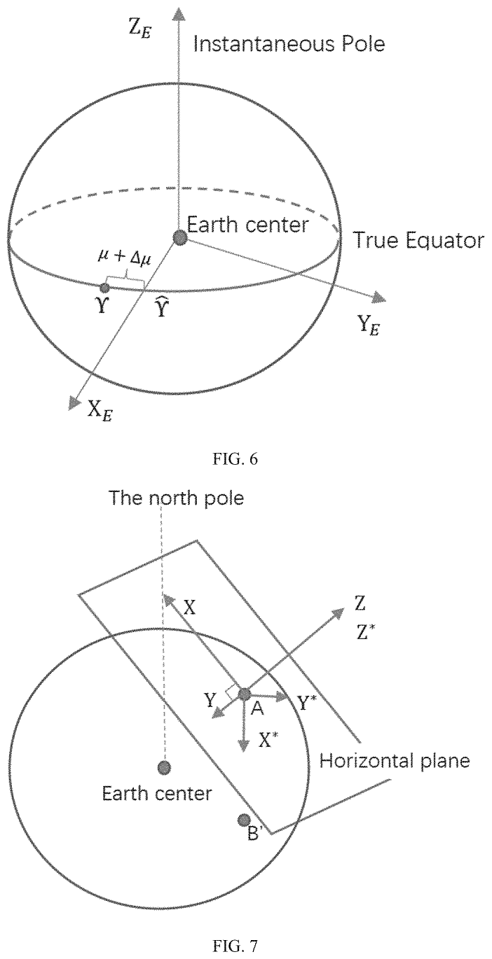

As shown in FIG. 6, the TEMEE coordinate system is a hybrid geocentric coordinate system, in which the reference plane is an instantaneous true equatorial plane, and the X-axis is located in the reference plane and points to the mean equinox of the epoch (epoch J2000.0 herein). The mean equinox is, in fact, an imaginary point on the instantaneous true equator, and is located μ+Δμ east of the true equinox, wherein μ is the general precession of right ascension, and Δμ is the nutation of the right ascension, which are computed with reference to Article 5 (Wu Lianda. Orbits and Detection of Artificial Satellites and Space Debris, China Science and Technology Press, 2011.). With the complementary advantages of the inertial system and the instantaneous true equatorial geocentric system, the TEMEE coordinate system not only avoids causing changes in the potential function of the earth's gravitational field, but also involves minimal additional perturbation that is negligible in solving problems requiring general precision. Hence, the TEMEE coordinate system is the preferred coordinate system for the analysis method of artificial satellites.

3. Conventional Horizontal Coordinate System and Target-Pointing Horizontal Coordinate System

As shown in FIG. 7, the conventional horizontal coordinate system takes the launch point of the missile as the origin and the horizontal plane passing through the origin as the reference plane, where the X-axis points to the north pole in the reference plane. In the target-pointing horizontal coordinate system, the X*-axis points to the target point B in the reference plane. The launch azimuth A* in the present invention is defined in the target-pointing horizontal coordinate system. In consideration of the research background of the present invention, the difference between the geoid and the reference ellipsoid can be ignored so that the tangent plane of the reference ellipsoid is used instead of the horizontal plane.

4. Transformation Matrix M from the Pseudo Body-Fixed Coordinate System to the TEMEE Coordinate System

The difference between the pseudo body-fixed coordinate system and the TEMEE coordinate system (epoch J2000.0) is only the Greenwich sidereal hour angle θ_{g} in the X-axis, so that the coordinate transformation matrix M is expressed as:

$$M = {R}_{Z} [ - {θ}_{g} ] = [ \begin{matrix}cos ( - {θ}_{g} ) & sin ( - {θ}_{g} ) & 0 \\ - sin ( - {θ}_{g} ) & cos ( - {θ}_{g} ) & 0 \\ 0 & 0 & 1\end{matrix} ] ;$$

wherein, θ_{g} is computed by:

$${θ}_{g} = 280 ° \cdot 460618375 + 36 {0}^{∘} \cdot 985612 \; 2882 d$$

d=MJD(UT1)−51544.5 is a Julian day number from 12^{h} UT₁ on Jan. 1, 2000 to the launch epoch t of the missile.

The transformation matrix from the TEMEE coordinate system to the pseudo body-fixed coordinate system is denoted as M^{T} in consideration of its orthogonality.

5. Transformation Matrix W from the Body-Fixed Coordinate System to the Conventional Horizontal Coordinate System

In a case where the difference between the origins of the body-fixed coordinate system and the conventional horizontal coordinate system is not considered, a transformation between the two coordinate systems is accomplished by two rotations using a transformation matrix that is a function of the geodetic latitude and longitude of the ground point. Assuming that the geodetic latitude and longitude of the ground point are L and B, respectively, then the transformation matrix W from the body-fixed coordinate system to the conventional horizontal coordinate system is:

$$W = {R}_{Y} [ B - π {/}_{2} ] \cdot {R}_{Z} [ L - π ] = [ \begin{matrix}- B sin B cos L & - sin B sin L & cos B \\ sin L & - cos L & 0 \\ cos B cos L & cos B sin L & sin B\end{matrix} ] ;$$

Similarly, the transformation matrix from the conventional horizontal coordinate system to the body-fixed coordinate system is denoted as W^{T}.

5. Transformation Matrix Q from the Conventional Horizontal Coordinate System to the Target-Pointing Horizontal Coordinate System

The conventional horizontal coordinate system and the target-pointing horizontal coordinate system have the same origin and reference plane, and only differ in the direction to which the X-axis points. In the conventional horizontal coordinate system, if the azimuth of the target point B is ϕ, then the classic horizontal coordinates are rotated counterclockwise around the Z-axis by ϕ to be transformed into the target-pointing horizontal coordinates. Accordingly, the transformation matrix Q is expressed by:

$$Q = {R}_{Z} [ ϕ ] = [ \begin{matrix}cos ϕ & sin ϕ & 0 \\ - sin ϕ & cos ϕ & 0 \\ 0 & 0 & 1\end{matrix} ] ;$$

Similarly, the transformation matrix from the target-pointing horizontal coordinate system to the conventional horizontal coordinate system is denoted as Q^{T}.

II. Implementation of the Present Invention in Conjunction with the Embodiments

Embodiment 1: All positive-flying and negative-flying free trajectories from the launch point A to the target point B are constructed based on randomly given launch epoch to of a missile and spherical coordinates of the two points (as shown in Table 1) by traversing using a two-body force model and a dynamic model including the J2 perturbation of the earth's gravitational field, respectively.

TABLE 1
Embodiment 1
(Launch epoch: 13:45:18.732 on Aug. 24, 2012 Beijing time;
launch angle h: traversed)

| | Geodetic longitude | Geodetic latitude | Geodetic height |
|---|---|---|---|
| Point | L (°) | B (°) | H (m) |
| A | 86.384 | −60.756 | 14.00 |
| B | 116.403 | 60.905 | 49.00 |

Embodiment 2: All positive-flying and negative-flying free trajectories from the launch point A (at the north pole) to the target point B are constructed based on randomly given launch epoch to of a missile and spherical coordinates of the point B (as shown in Table 2) by traversing using a two-body force model and a dynamic model including the J2 perturbation of the earth's gravitational field, respectively.

TABLE 2
Embodiment 2
(Launch epoch: 13:55:25.6 on May 18, 2012 Beijing time;
launch angle h: traversed)

| | Geodetic longitude | Geodetic latitude | Geodetic height |
|---|---|---|---|
| Point | L (°) | B (°) | H (m) |
| A | ∀L_{A} ∈ [0, 360) | 90.000 | 1000.00 |
| B | 240.500 | −45.905 | 0.00 |

In addition to the above known parameters, the present invention also involves the following geophysical constants:

Equatorial radius of the reference ellipsoid: αₑ=6378136 m.

Geocentric gravitational constant: μ=0.39860043770442×10¹⁵ m³/s².

Oblateness of the earth: f=1/298.25781.

Eccentricity of the meridian of the earth: e_{c}²=2f−f²=0.0066946.

Among the above parameters, the launch epoch and the geodetic coordinates of the launch point are known, and the coordinates of the launch point in the inertial space are obtained by rotating the coordinate system. Due to the rotation of the earth, the position of the target point in the inertial space changes at all times. In this regard, the flight time is a key variable for the constructed trajectory to hit the target point with a changing position, and the flight time is computed based on the position of the target point in the inertial space. In the present invention, two variables of the flight time and inertial coordinates of the target point are iteratively computed simultaneously by specific steps as follows:

Step 1: data preprocessing: the 3D rectangular coordinate vector \vec{R}_{A} of the launch point A and the 3D rectangular coordinate vector \vec{R}_{B} of the target point B, the difference Δ_{φ} between the geodetic latitude and the geocentric latitude of the launch point A, the horizontal angle ϕ between the AB direction and the north-pole direction of the launch point in the body-fixed coordinate system and the difference ε between a ratio of the modulus of the geocentric radius vector of the point A to the modulus of the geocentric radius vector of the point B and 1 are sequentially computed.

Step 1 includes the following sub-steps:

1. The geodetic coordinates of the points A and B are transformed from spherical coordinates (L, B, H) to 3D rectangular coordinates (X, Y, Z) according to equation (1), and the 3D rectangular coordinates are expressed by \vec{R}_{A} and \vec{R}_{B} as:

$$\{ \begin{matrix}X = ( N + H ) cos B cos L \\ Y = ( N + H ) cos B sin L \\ Z = [ N ( 1 - {e}_{c}^{2} ) + H ] sin B\end{matrix} ; \qquad equation ( 1 )$$

wherein, N is the radius of curvature of the prime vertical of a point, and N=αₑ/\sqrt{1−e_{c}²(sin B)²}.

In Embodiment 2, the point A is located at the north pole, and thus its geodetic longitude is indefinite. In the present invention, the geodetic longitude of the point A is specified as an arbitrary value between 0° and 360°, such that the construction of trajectories is carried out smoothly without affecting the result.

2. The geocentric latitudes φ_{A} and φ_{B} of the points A and B are computed according to equation (2):

$$φ = {sin}^{- 1} \frac{z}{\sqrt{{X}^{2} + {Y}^{2} + {Z}^{2}}} . \qquad equation ( 2 )$$

3. The difference Δ₁₀₀ between the geodetic latitude and the geocentric latitude of the point A is computed according to equation (3):

$$Δφ = {B}_{A} - {φ}_{A} . \qquad equation ( 3 )$$

4. The horizontal angle ϕ between the AB direction and the north-pole direction of the launch point in the body-fixed coordinate system is computed according to equations (4) and (5):

$$\{ \begin{matrix}sin ϕ = \frac{cos {B}_{B} sin ( {L}_{A} - {L}_{8} )}{sin q} \\ cos ϕ = \frac{sin {B}_{B} cos {B}_{A} - cos {B}_{B} sin {B}_{A} cos ( {L}_{A} - {L}_{B} )}{sin q}\end{matrix} ; \qquad equation ( 4 )$$

wherein, q is the zenith angle of the point B from the zenith of the point A, and is computed by:

$$\{ \begin{matrix}cos q = sin {B}_{B} sin {B}_{A} + cos {B}_{B} cos {B}_{A} cos ( {L}_{A} - {L}_{B} ) \\ sin q = \sqrt{1 - {cos}^{2} q} \end{matrix} q ∈ ( 0 , π ) . \qquad equation ( 5 )$$

In a particular case where the launch point is located at or above the north or south pole, equations (4) and (5) are still satisfied, and are simplified as:

$$\{ \begin{matrix}ϕ = π - ( {L}_{A} - {L}_{B} ) & A is at or above the north pole \\ ϕ = {L}_{A} - {L}_{B} & A is at or above the south pole\end{matrix} ∀ {L}_{A} ∈ [ 0 , 360 ° ) .$$

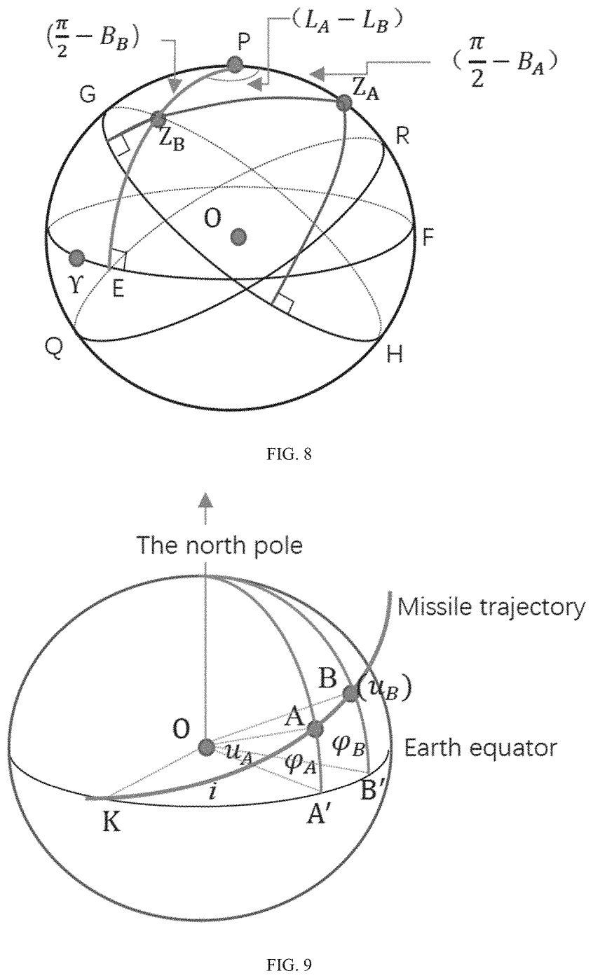

Equations (4) and (5) are derived from the formulas of spherical trigonometry applied to the spherical triangle O-PZ_{A}Z_{B} in FIG. 8. O is the center of the earth. P, Z_{A}, Z_{B} and γ are the projections of the north pole, the zenith of the launch point, the zenith of the target point and the equinox on the celestial sphere, respectively. The great circle defined by [symbol] is an extension of the equator on the celestial sphere, where E is the intersection point of the great circle passing P and Z_{B} and the equatorial plane, and F is the intersection point of the great circle passing P and Z_{A} and the equatorial plane. The great circle defined by [symbol] is perpendicular to OZ_{A}; and the great circle defined by [symbol] is perpendicular to OZ_{B}. The difference between the geoid and the reference ellipsoid is ignored, such that angular distance ∠POZ_{B} represents the complementary angle of the geodetic latitude of the point B and is equal to

$$( \frac{π}{2} - {B}_{B} ) .$$

Angular distance ∠POZ_{A} represents the complementary angle of the geodetic latitude of the point A and is equal to

$$( \frac{π}{2} - {B}_{A} ) .$$

Spherical angle Z_{B}PZ_{A} represents an angle between meridians passing through the points A and B, and is equal to (L_{A}−L_{B}). Spherical angle ∠Z_{A}PZ_{B} is the zenith angle of the point B from the zenith of the point A and is denoted as q. ∠Z_{B}Z_{A}P is denoted as ϕ to be computed. According to the law of sines of spherical trigonometry and the five-element formulas, the following two equations are derived:

$$\{ \begin{matrix}\frac{sin ϕ}{sin ( \frac{π}{2} - {B}_{B} )} = \frac{sin ( {L}_{A} - {L}_{B} )}{sin q} \\ sin q cos ϕ = cos ( \frac{π}{2} - {B}_{B} ) sin ( \frac{π}{2} - {B}_{A} ) - \\ sin ( \frac{π}{2} - {B}_{B} ) cos ( \frac{π}{2} - {B}_{A} ) cos ( {L}_{A} - {L}_{B} )\end{matrix} ,$$

simplified as the following equations for computing ϕ:

$$\{ \begin{matrix}sin ϕ = \frac{cos {B}_{B} sin ( {L}_{A} - {L}_{B} )}{sin q} \\ cos ϕ = \frac{sin {B}_{8} cos {B}_{A} - cos {B}_{B} sin {B}_{A} cos ( {L}_{A} - {L}_{B} )}{sin q}\end{matrix} .$$

According to the law of cosines of spherical trigonometry, q is expressed by:

$$cos q = cos ( \frac{π}{2} - {B}_{B} ) cos ( \frac{π}{2} - {B}_{A} ) + sin ( \frac{π}{2} - {B}_{B} ) sin ( \frac{π}{2} - {B}_{A} ) cos ( {L}_{A} - {L}_{B} ) ,$$

rewritten as:

$$\{ \begin{matrix}cos q = {sin B}_{B} {sin B}_{A} + {cos B}_{B} {cos B}_{A} cos ( {L}_{A} - {L}_{B} ) \\ sin q = \sqrt{1 - {cos}^{2} q}\end{matrix} \\ q ∈ ( 0 , π ) ;$$

wherein the value of q is limited within (0,π). The two points A and B must not coincide or be located at the two ends of the diameter of the earth for the following reason. If the target point and the launch point coincide, then it does not meet the actual need for constructing a trajectory. If the target point and the launch point are located at the two ends of the diameter of the earth, then there exist countless elliptical trajectories passing through the two points at the specified launch angle, such that it is impossible to derive a unique set of designed parameters of the missile.

5. The difference ε between a ratio of the modulus of the geocentric radius vector of the point A to the modulus of the geocentric radius vector of the point B and 1 is computed according to equation (6):

$$ɛ = \frac{\vert {\vec{R}}_{B} \vert}{\vert {\vec{R}}_{A} \vert} - 1. \qquad equation ( 6 )$$

The moduli of the geocentric radius vectors of the points A and B are typically not equal, and the geodetic height difference between the points A and B is much smaller than the radius of the earth. Thus, ε is typically a small non-zero quantity.

Step 2: setting of the initial state of iterations: assuming that the earth does not rotate and the flight time T is zero.

If the earth does not rotate, the launch velocity vₚ of the missile in the body-fixed coordinate system is equal to the launch velocity vᵣ in the TEMEE coordinate system, that is,

$$\frac{{v}_{p}}{{v}_{r}} = 1.$$

Meanwhile, the launch azimuth A* in the target-pointing horizontal coordinate system is zero.

Step 3: the launch velocity vector \vec{\dot{r}}_{A} of the positive-flying trajectory or the negative-flying trajectory in the TEMEE coordinate system and the launch velocity vector \vec{\dot{R}}_{A} of the positive-flying trajectory or the negative-flying trajectory in the body-fixed coordinate system, the orbital elements σ of the missile at the launch epoch, the flight time and a plurality of other variables are computed in the two-body force model to obtain a new flight time T*.

Step 3 includes the following sub-steps:

1. The coordinate vectors \vec{r}_{A} and \vec{r}_{B} of the points A and B in the TEMEE coordinate system are computed in combination with the flight time T according to equation (7):

$$\{ \begin{matrix}{\vec{r}}_{A} = M ( {t}_{0} ) {\vec{R}}_{A} \\ {\vec{r}}_{B} = M ( {t}_{0} + T ) {\vec{R}}_{B}\end{matrix} ; \qquad equation ( 7 )$$

wherein, t₀ is the launch epoch, and M is a time-dependent transformation matrix transformation matrix from the body-fixed coordinate system to the TEMEE coordinate system. In the first iteration, the flight time T is zero, and \vec{r}_{B}=M(t₀)\vec{R}_{B} is satisfied.

2. The half-range angle β is computed according to equations (8) and (9):

a half intersection angle is expressed by:

$$δ = \frac{1}{2} \times {cos}^{- 1} \frac{{\vec{r}}_{A} \cdot {\vec{r}}_{B}}{\vert {\vec{r}}_{A} \vert \vert {\vec{r}}_{B} \vert} ; \qquad equation ( 8 )$$

then the half-range angle is computed by:

$$β = \{ \begin{matrix}δ & β ∈ ( 0 , \frac{π}{2} ) & positive - flying trajectory \\ π - δ & β ∈ ( \frac{π}{2} , π ) & negative - flying trajectory\end{matrix} ; \qquad equation ( 9 )$$

3. The inclination i and the right ascension Ω of the ascending node of the elliptical trajectory/orbit are computed according to equation (10):

$$\{ \begin{matrix}[ \begin{matrix}sin i sinΩ \\ - sin i cosΩ \\ cos i\end{matrix} ] = \frac{{\vec{r}}_{A} \cdot {\vec{r}}_{B}}{\vert {\vec{r}}_{A} \times {\vec{r}}_{B} \vert} & positive - flying trajectory \\ [ \begin{matrix}sin i sinΩ \\ - sin i cosΩ \\ cos i\end{matrix} ] = \frac{{\vec{r}}_{B} \cdot {\vec{r}}_{A}}{\vert {\vec{r}}_{B} \times {\vec{r}}_{A} \vert} & negative - flying trajectory\end{matrix} \\ i ∈ ( 0 , π ) \\ Ω ∈ [ 0 , 2 π ) . \qquad equation ( 10 )$$

4. The true arguments of latitude μ_{A} and μ_{B} of the points A and B on the elliptical trajectory/orbit are computed according to equation (11):

$$\{ \begin{matrix}{sin u}_{A} = \frac{{sinφ}_{A}}{sin i} \\ {cos u}_{A} = \frac{{sinφ}_{B} - {sinφ}_{A} cos2β}{sin i sin2β} ; \\ {u}_{B} = {u}_{A} + 2 β\end{matrix} \qquad equation ( 11 )$$

Equation (11) is derived from the law of sines applied to the spherical triangles in FIG. 9. In the spherical triangle O-KAA′, spherical angle ∠AKA′ is equal to the orbital inclination i of the trajectory; angular distance ∠AOA′ is equal to the geocentric latitude φ_{A} of the point A; angular distance ∠AOK is equal to the true argument of latitude μ_{A} of the point A; and sin μ_{A} is expressed according to the law of sines as follows:

$${sin u}_{A} = \frac{{sinφ}_{A}}{sin i} .$$

Similarly, in the spherical triangle O-KBB′,

$${sin u}_{B} = \frac{{sinφ}_{B}}{sin i} .$$

The half-range angle β is known and μ_{B}=μ_{A}+2β is satisfied, which is substituted into the above equations to obtain:

$${sin u}_{B} = sin ( {u}_{A} + 2 β ) = {sin u}_{A} cos2β + {cos u}_{A} sin2β .$$

The expressions of sin μ_{A} and sin μ_{B} are substituted to obtain:

$$\frac{{sinφ}_{B}}{sin i} = \frac{{sinφ}_{A}}{sin i} cos2β + {cos u}_{A} sin2β ,$$

simplified as:

$${cos u}_{A} = \frac{{sinφ}_{B} - {sinφ}_{A} cos2β}{sin i sin2β} .$$

5. The cosine of the angle α between the launch velocity vector and the geocentric radius vector of the launch point in the body-fixed coordinate system is computed according to equation (12):

$$cosα = cosΔφsin h - sinΔφcos h cos ( {A}^{*} - ϕ ) ; \qquad equation ( 12 )$$

wherein, h is the launch angle, and A*=0 in the first iteration.

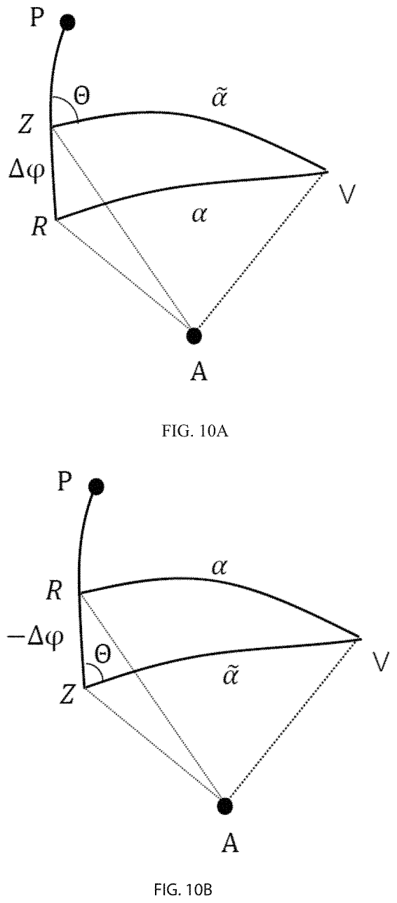

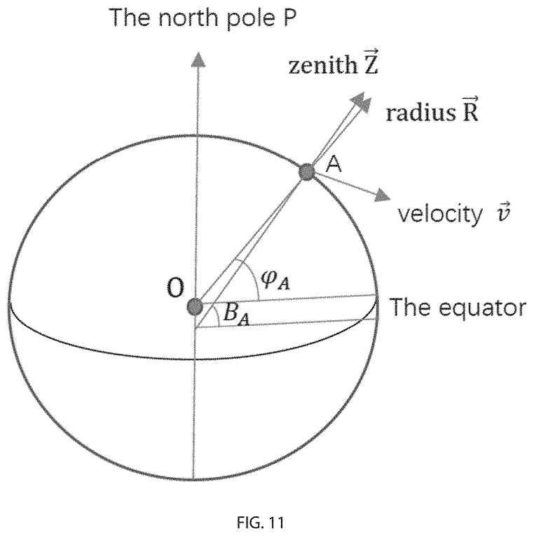

Equation (12) is derived from the law of cosines applied to the spherical triangles in FIG. 10A and FIG. 10B. The spherical triangle in FIG. 10A and FIG. 10B is formed by the projections of the velocity vector, radius vector and zenith of the point A on the celestial sphere, where the spatial directions of the velocity, the zenith and the radius vector of the point A are shown in FIG. 11. In the spherical triangle A-ZRV, angular distance ∠ZAR represents the difference Δ₁₀₀ between the geodetic latitude and the geocentric latitude of the point A. According to the definition of the launch angle h, angular distance ∠ZAV is the complementary angle of h, namely

$$\tilde{α} = \frac{π}{2} - h .$$

∠PZV is the azimuth of the launch velocity vector and denoted as Θ, which is equal to (A*−ϕ). Angular distance ∠VAR is the angle α between the launch velocity vector and the geocentric radius vector of the launch point in the body-fixed coordinate system and is to be computed. According to the law of cosines, the angle is expressed by:

$$cos α = cos Δφcos \tilde{α} + sin Δφsin \tilde{α} cos ( π - θ ) ;$$

\tilde{α} and Θ are substituted into the above equation to obtain:

$$cos α = cos Δφsinh - sin Δφcos h cos ( {A}^{*} - ϕ ) .$$

6. The tangent of the angle θ between the launch velocity vector and the geocentric radius vector of the launch point in the TEMEE coordinate system is computed according to equation (13):

$$\{ \begin{matrix}cos θ = \frac{{v}_{P}}{{v}_{r}} cos α \\ sin θ = \sqrt{1 - {cos}^{2} θ} \\ cot θ = \frac{cos θ}{sin θ}\end{matrix} \qquad equation ( 13 )$$

Due to the rotation of the earth, the launch velocity vector in the TEMEE coordinate system is a resultant of the launch velocity vector in the body-fixed coordinate system and the rotational velocity vector of the earth. Since the rotational velocity vector of the earth is perpendicular to the geocentric radius vector, the launch velocity vectors in the two coordinate systems have equal components in the direction of the geocentric radius vector. Accordingly:

$${\dot{\vec{r}}}_{A} \cdot \frac{{\vec{r}}_{A}}{\vert {\vec{r}}_{A} \vert} = {\dot{\vec{R}}}_{A} \cdot \frac{{\vec{R}}_{A}}{\vert {\vec{R}}_{A} \vert} ,$$

simplified as:

$$\vert {\dot{\vec{r}}}_{A} \vert cos θ = \vert {\dot{\vec{R}}}_{A} \vert cos α .$$

Because |\vec{\dot{r}}_{A}|=vᵣ; |\vec{\dot{R}}_{A}|=vₚ, the above equation can be rewritten as:

$${v}_{r} cos θ = {v}_{P} cos α ;$$

wherein, in the first iteration,

$$\frac{{v}_{P}}{{v}_{r}} = 1 .$$

7. A bias Δω of the argument of perigee is introduced and computed according to equation (15), and then the argument of perigee ω is computed according to equation (14).

According to the nature of the elliptical trajectory/orbit, the apogee of the trajectory is located in an outer space of the earth and between the points A and B. When the geocentric radius vector moduli of the points A and B are equal, the argument of apogee is equal to the mean value of the true arguments of latitude of the points A and B, and the mean value minus π obtains the argument of perigee ω. The argument of perigee ω computed in this way, however, generally has a deviation due to unequal geocentric distances of the point A and the point B. The bias Δω of ω is introduced to obtain:

$$ω = {ω}_{0} + Δω ω ∈ [ 0 , 2 π ) ; \qquad equation ( 14 )$$

wherein,

$${ω}_{0} = \frac{{u}_{A} + {u}_{B}}{2} - π ,$$

wherein μ_{A} and μ_{B} have been computed according to equation (11); Δω is computed according to equation (15):

$$tan Δ ω = \frac{ɛ}{2 ( 1 + ɛ ) cot θ - ɛ cot β} Δω ∈ [ - \frac{π}{2} , \frac{π}{2} ] ; \qquad equation ( 15 )$$

accordingly, the true anomalies of the points A and B on the elliptical trajectory/orbit are expressed by Δω as follows:

$$\{ \begin{matrix}{f}_{A} = π - β - Δ ω \\ {f}_{B} = π + β - Δ ω\end{matrix} . \qquad equation ( 16 )$$

Equation (15) is derived as follows. A polar coordinate system is established on an orbital plane, then a polar coordinate equation of an elliptic curve is expressed as:

$$r = \frac{p}{1 + e cos f} ;$$

wherein, p is a semi-laths rectum. The polar radii of the points A and B are:

$$\{ \begin{matrix}{r}_{A} = \frac{p}{1 + e cos {f}_{A}} \\ {r}_{B} = \frac{p}{1 + e cos {f}_{B}}\end{matrix} ;$$

r_{A}=|\vec{R}_{A}| and r_{B}=|\vec{R}_{B}| are substituted into equation (6) to obtain:

$$ɛ = \frac{1 + e cos {f}_{A}}{1 + e cos {f}_{B}} - 1 ,$$

rewritten as:

$$1 + e cos {f}_{A} = ( 1 + ɛ ) ( 1 + e cos {f}_{B} ) .$$

The expressions of f_{A} and f_{B} in equation (16) are substituted to obtain:

$$sin Δω = \frac{ɛ ( 1 - e cos ( β - Δ ω ) )}{2 e sin β} .$$

Equation (17) for computing e is substituted into the expression of sin Δω to obtain the most compact form expressed as equation (15).

8. The eccentricity e of the elliptical trajectory/orbit is computed according to equation (17).

$$e = \frac{cot θ}{sin ( β + Δ ω ) + cot θ cos ( β + Δ ω )} ; \qquad equation ( 17 )$$

wherein, θ is the angle between the launch velocity vector of the missile and the geocentric radius vector in the TEMEE coordinate system, and is determined jointly by the eccentricity of the elliptical orbit and the true anomaly of the launch point. The relationship between the three is expressed as:

$$tan θ = \frac{1 + e cos {f}_{A}}{e sin {f}_{A}} ,$$

rewritten as:

$$e = \frac{cot θ}{sin {f}_{A} - cot θ cos {f}_{A}} ,$$

f_{A}=π−β−Δω is substituted into the above equation to obtain:

$$e = \frac{cot θ}{sin ( β + Δ ω ) + cot θ cos ( β + Δ ω )} .$$

9. The rationality of the specified launch angle h is judged as follows. If any one of the following conditions is satisfied, then the specified launch angle is judged to be irrational such that a rationally designed trajectory cannot be obtained, the current construction procedure of the trajectory is ended, and a launch angle is re-specified.

For the positive-flying trajectory:

(1) If e≥1, then the specified launch angle is judged to be excessively large; and

(2) If cot θ≤0 or |tan Δω|≥tan β, then the specified launch angle is judged to be excessively small.

For the negative-flying trajectory:

$$If e \geq 1 or cot θ \geq - tan β + \frac{ɛ}{2 ( 1 + ɛ )} ( tan β + cot β ) , \qquad ( 1 )$$

then the specified launch angle is judged to be excessively large; and

$$If cot θ \leq max \{ \frac{ɛ}{2 ( 1 + ɛ )} cot β , 0 \} , \qquad ( 2 )$$

then the specified launch angle is judged to be excessively small.

10. The true anomalies f_{A} and f_{B} of the points A and B on the elliptical trajectory/orbit are computed according to equation (16).

11. The orbital elements a of the missile at the launch epoch are computed according to equations (18) to (21).

σ is a set of the first type of non-singular orbital elements, wherein the inclination i and the right ascension Ω of the ascending node of the orbit are computed according to equation (10), and a semi-major axis α and ξ, η, λ are computed as follows:

$$\begin{matrix}a = \frac{\vert {\vec{r}}_{A} \vert [ 1 - e cos ( β + Δ ω ) ]}{1 - {e}^{2}} ; & equation ( 18 ) \\ \{ \begin{matrix}ξ = e cos ω \\ η = - e sin ω \\ λ = ω + {M}_{A}\end{matrix} ; & equation ( 19 )\end{matrix}$$

wherein M_{A} is computed as follows:

$$\begin{matrix}\{ \begin{matrix}{E}_{A} = {f}_{A} - 2 {tan}^{- 1} ( \frac{e sin {f}_{A}}{1 + \sqrt{1 - {e}^{2}} + e cos {f}_{A}} ) \\ {E}_{B} = {f}_{B} - 2 {tan}^{- 1} ( \frac{e sin {f}_{B}}{1 + \sqrt{1 - {e}^{2}} + e cos {f}_{B}} )\end{matrix} ; & equation ( 20 ) \\ \{ \begin{matrix}{M}_{A} = {E}_{A} - e sin {E}_{A} \\ {M}_{B} = {E}_{B} - e sin {E}_{B}\end{matrix} . & equation ( 21 )\end{matrix}$$

12. The flight time T* of the missile is computed according to equation (22):

$$\{ \begin{matrix}{T}^{*} = \frac{{M}_{B} - {M}_{A}}{n} \\ n = \sqrt{μ / {a}^{3}}\end{matrix} . \qquad equation ( 22 )$$

13. The launch velocity vᵣ of the missile in the TEMEE coordinate system and the launch velocity vₚ of the missile in the body-fixed coordinate system are computed according to equations (23) to (25), where the launch velocity vectors \vec{\dot{r}}_{A} and \vec{\dot{R}}_{A} of the missile in the TEMEE coordinate system and the body-fixed coordinate system satisfy:

$$\begin{matrix}\{ \begin{matrix}{{r}^{\dot{\to }}}_{A} = \sqrt{\frac{μ}{p}} [ ( - sin {u}_{A} + η ) \vec{P} + ( cos {u}_{A} + ξ ) \vec{Q} ] \\ \vec{P} = [ \begin{matrix}cos Ω \\ sin Ω \\ 0\end{matrix} ] \\ \vec{Q} = [ \begin{matrix}- sin Ω cos i \\ cos Ω cos i \\ sin i\end{matrix} ] \\ p = a ( 1 - {e}^{2} )\end{matrix} ; & equation ( 23 ) \\ {{R}^{\dot{\to }}}_{A} = M ( {t}_{0} ) {{r}^{\dot{\to }}}_{A} - {\dot{θ}}_{g} [ \begin{matrix}- {Y}_{A} \\ {X}_{A} \\ 0\end{matrix} ] ; \\ then \text{:} & equation ( 24 ) \\ \{ \begin{matrix}{v}_{p} = \vert {{R}^{\dot{\to }}}_{A} \vert \\ {v}_{r} = \vert {{r}^{\dot{\to }}}_{A} \vert\end{matrix} ; & equation ( 25 )\end{matrix}$$

wherein, \dot{θ}_{g} is a change rate of the Greenwich sidereal hour angle in the TEMEE coordinate system and is 360°.985612288/day.

14. The launch azimuth A* in the target-pointing horizontal coordinate system is computed according to equations (26) and (27):

the launch velocity vector in the target-pointing horizontal coordinate system is denoted as \vec{\dot{R}}_{A*}(X*, Y*, Z*), and which is derived by performing a coordinate rotation on \vec{\dot{R}}_{A} as follows:

$$\begin{matrix}{{R}^{\dot{\to }}}_{{A}^{*}} = QW {{R}^{\dot{\to }}}_{A} ; \\ & equation ( 26 ) \\ [ \begin{matrix}{X}^{*} \\ {Y}^{*} \\ {Z}^{*}\end{matrix} ] = \vert {{R}^{\dot{\to }}}_{{A}^{*}} \vert [ \begin{matrix}cos h cos {A}^{*} \\ - cos h sin {A}^{*} \\ sin h\end{matrix} ] ; & equation ( 27 )\end{matrix}$$

wherein, W is a rotation matrix from the body-fixed coordinate system to the conventional horizontal coordinate system, and Q is a rotation matrix from the conventional horizontal coordinate system to the target-pointing horizontal coordinate system.

Step 4: let T=T*, step 3 is repeated to iteratively compute the launch velocity vector of the missile, the orbital elements of the missile at the launch epoch, the half-range angle, the flight time and a plurality of other variables until |T−T*| is less than the set threshold Sₜ to complete the iterations to finally obtain the launch velocity vector \vec{\dot{r}}_{A} and the flight time T of the missile in the two-body force model.

Step 4 includes the following sub-steps:

1. It is judged whether |T−T*|<Sₜ is satisfied; if yes, let T=T*, and proceeding to the next step; otherwise, let T=T*, and returning to step 3.

2. The declination Ã of the launch velocity vector in the target-pointing horizontal coordinate system relative to the target point in the horizontal plane is computed according to equation (28):

$$\{ \begin{matrix}\tilde{A} = {A}^{*} & {A}^{*} \leq π \\ \tilde{A} = {A}^{*} - 2 π & {A}^{*} > π\end{matrix} . \qquad equation ( 28 )$$

3. The designed parameters vₚ, vᵣ, Ã, T, σ of the missile obtained based on the two-body force model are output.

Step 5: the launch velocity vector \vec{\dot{r}}_{A} and the flight time T obtained by the two-body force model are taken as reference solutions \vec{\dot{r}}_{A}⁰ and T⁰ for the differential correction; if the distance |Δ\vec{R}_{BB*}| between the target point B and the target point B* obtained by a perturbation extrapolation based on the reference solutions is less than the given threshold S_{R}, then the correction of the designed parameters of the missile is ended, and corrected parameters vₚ, vᵣ, Ã, T, σ are output; otherwise, proceeding to step 6.

Step 5 includes the following sub-steps:

1. The target point obtained by the perturbation extrapolation based on the reference solutions \vec{\dot{r}}_{A}⁰ and T⁰ is denoted as B*, and partial derivative matrices

$$\frac{\partial {\vec{r}}_{{B}^{*}}}{\partial {\vec{r}}_{A}} , \frac{\partial {\vec{r}}_{{B}^{*}}}{\partial T}$$

and a position vector \vec{r}_{B*} of B* in the TEMEE coordinate system are computed by a numerical integration.

To adapt to computing highly-eccentric trajectories, the numerical integration is performed by a Gragg-Bulirsch-Stoer first-order integrator, where the differential equations to be integrated are:

$$\{ \begin{matrix}\frac{d \vec{r}}{dt} = \vec{v} \\ \frac{d \vec{v}}{d t} = \vec{F} ( \vec{r} ) \\ \frac{d}{d t} ( \frac{\partial \tilde{r}}{\partial {\dot{\vec{r}}}_{A}} ) = \frac{\partial \vec{v}}{\partial {\dot{\vec{r}}}_{A}} \\ \frac{d}{d t} ( \frac{\partial \vec{v}}{\partial {\dot{\vec{r}}}_{A}} ) = \frac{\partial \vec{F}}{\partial \vec{r}} \cdot \frac{\partial \vec{r}}{\partial {\dot{\vec{r}}}_{A}}\end{matrix} ; \qquad equation ( 29 )$$

derive initial values as:

$$\{ \begin{matrix}\vec{r} ( {t}_{0} ) = {\vec{r}}_{A} \\ \vec{v} ( {t}_{0} ) = {\dot{\vec{r}}}_{A}^{0} \\ {\frac{\partial \vec{r}}{\partial {\dot{\vec{r}}}_{A}} \vert}_{t = {t}_{0}} = 0 \\ {\frac{\partial \vec{ν}}{\partial {\dot{\vec{r}}}_{A}} \vert}_{t = {t}_{0}} = I\end{matrix} ; \qquad equation ( 30 )$$

integrate from t=t₀ to t=t₀+T⁰ to obtain:

$$\{ \begin{matrix}{{\vec{r}}_{{B}^{*}} = \vec{r} \vert}_{t = {t}_{0} + {T}^{0}} \\ {\frac{\partial {\vec{r}}_{{B}^{*}}}{\partial T} = \vec{v} \vert}_{t = {t}_{0} + {T}^{0}} \\ {\frac{\partial {\vec{r}}_{{B}^{*}}}{\partial {\dot{\vec{r}}}_{A}} = \frac{\partial \vec{r}}{\partial {\dot{\vec{r}}}_{A}} \vert}_{t = {t}_{0} + {T}^{0}}\end{matrix} ; \qquad equation ( 31 )$$

the force function \vec{F}(\vec{r}) only including the J2 perturbation and its partial derivative matrix

$$\frac{\partial \vec{F}}{\partial \vec{r}}$$

in equation (29) are expressed as:

$$\{ \begin{matrix}\vec{F} = {( ∇ U )}_{r} = M ( t ) \cdot {( ∇ U )}_{R} \\ \frac{\partial \vec{F}}{\partial \vec{r}} = {( {∇}^{2} U )}_{r} = M ( t ) \cdot {( {∇}^{2} U )}_{R} \cdot {M}^{T} ( t )\end{matrix} ; \qquad equation ( 32 )$$

wherein, t is an integration time; subscripts r and R represent a gradient or tensor of U in the TEMEE coordinate system and the body-fixed coordinate system, respectively; U represents a gravitational potential function of the earth in the body-fixed coordinate system and includes a central gravitational potential U₀ and a J₂ gravitational potential U₁:

$$U = {U}_{0} + {U}_{1} . \qquad equation ( 33 )$$

Accordingly, the gradient and tensor of the gravitational potential function U of the earth are obtained as follows:

$$\begin{matrix}\{ \begin{matrix}{( ∇ U )}_{R} = {( ∇ {U}_{0} )}_{R} + {( ∇ {U}_{1} )}_{R} \\ {( {∇}^{2} U )}_{R} = {( {∇}^{2} {U}_{0} )}_{R} + {( {∇}^{2} {U}_{1} )}_{R}\end{matrix} ; \\ wherein , & equation ( 34 ) \\ \{ \begin{matrix}{( ∇ {U}_{0} )}_{R} = - \frac{μ}{{r}^{3}} {( X , Y , Z )}^{T} \\ {( {∇}^{2} {U}_{0} )}_{R} = \frac{μ}{{r}^{3}} [ \begin{matrix}- 1 + 3 \frac{{X}^{2}}{{r}^{2}} & \frac{3 XY}{{r}^{2}} & \frac{3 XZ}{{r}^{2}} \\ \frac{3 XY}{{r}^{2}} & - 1 + 3 \frac{{Y}^{2}}{{r}^{2}} & \frac{3 Y Z}{{r}^{2}} \\ \frac{3 XZ}{{r}^{2}} & \frac{3 Y Z}{{r}^{2}} & 1 + 3 \frac{{Z}^{2}}{{r}^{2}}\end{matrix} ] \\ {( ∇ {U}_{1} )}_{R} = {( \frac{\partial {U}_{1}}{\partial X} , \frac{\partial {U}_{1}}{\partial Y} , \frac{\partial {U}_{1}}{\partial Z} )}^{T} \\ {( {∇}^{2} {U}_{1} )}_{R} = [ \begin{matrix}\frac{{\partial }^{2} {U}_{1}}{\partial {X}^{2}} & \frac{{\partial }^{2} {U}_{1}}{\partial X \partial Y} & \frac{{\partial }^{2} {U}_{1}}{\partial X \partial Z} \\ \frac{{\partial }^{2} {U}_{1}}{\partial Y \partial X} & \frac{{\partial }^{2} {U}_{1}}{\partial {Y}^{2}} & \frac{{\partial }^{2} {U}_{1}}{\partial Y \partial Z} \\ \frac{{\partial }^{2} {U}_{1}}{\partial Z \partial X} & \frac{{\partial }^{2} {U}_{1}}{\partial Z \partial Y} & \frac{{\partial }^{2} {U}_{1}}{\partial {Z}^{2}}\end{matrix} ] \end{matrix} ; & equation ( 35 )\end{matrix}$$

wherein, (X, Y, Z)^{T} is a 3D rectangular coordinate vector of the missile in the body-fixed coordinate system, and r=R=\sqrt{X²+Y²+Z²}. With reference to Article 6 (Balmino G, Barriot J P, Valès N. Non-singular formulation of the gravity vector and gravity gradient tensor in spherical harmonics [J]. Manuscr Geod, 1990, 15.), the elements composing the above matrices or vectors are expressed by:

$$\{ \begin{matrix}let {θ}_{1} = \frac{X}{r} ; {θ}_{2} = \frac{Y}{r} ; {θ}_{3} = \frac{Z}{r} = ζ \\ {\overline{P}}_{2} ( ζ ) = \sqrt{5} \times \frac{( 3 {ζ}^{2} - 1 )}{2} ; {\overline{P}}_{2}^{′} ( ζ ) = 3 \sqrt{5} ζ ; {\overline{P}}_{2}^{′′} ( ζ ) = 3 \sqrt{5} \\ {D}_{r} = - 3 {{\overline{C}}_{20} ( \frac{{a}_{e}}{r} )}^{2} {\overline{P}}_{2} ( ζ ) ; {D}_{3} = {{\overline{C}}_{20} ( \frac{{a}_{e}}{r} )}^{2} {\overline{P}}_{2}^{′} ( ζ ) \\ {S}_{r r} = 12 {{\overline{C}}_{20} ( \frac{{a}_{e}}{r} )}^{2} {\overline{P}}_{2} ( ζ ) ; {S}_{r 3} = - 3 {{\overline{C}}_{20} ( \frac{{a}_{e}}{r} )}^{2} {\overline{P}}_{2}^{′} ( ζ ) ; {S}_{33} = {{\overline{C}}_{20} ( \frac{{a}_{e}}{r} )}^{2} {\overline{P}}_{2}^{′′} ( ζ ) \\ \tilde{ϕ} = {D}_{r} - {D}_{3} {θ}_{3} \\ \frac{\partial {U}_{1}}{\partial X} = \frac{μ}{{r}^{2}} \tilde{ϕ} {θ}_{1} ; \frac{\partial {U}_{1}}{\partial Y} = \frac{μ}{{r}^{2}} \tilde{ϕ} {θ}_{2} ; \frac{\partial {U}_{1}}{\partial Z} = \frac{μ}{{r}^{2}} ( {D}_{3} + \tilde{ϕ} {θ}_{3} ) \\ \frac{{\partial }^{2} {U}_{1}}{\partial {X}^{2}} = \frac{μ}{{r}^{3}} \{ \tilde{ϕ} + [ {S}_{r r} + 2 ( {D}_{3} - {S}_{r 3} ) {θ}_{3} - \tilde{ϕ} + {S}_{33} {θ}_{3}^{2} ] {θ}_{1}^{2} \} \\ \frac{{\partial }^{2} {U}_{1}}{\partial X \partial Y} = \frac{μ}{{r}^{3}} [ {S}_{r r} + 2 ( {D}_{3} - {S}_{r 3} ) {θ}_{3} - \tilde{ϕ} + {S}_{33} {θ}_{3}^{2} ] {θ}_{1} {θ}_{2} \\ \frac{{\partial }^{2} {U}_{1}}{\partial X \partial Z} = \frac{μ}{{r}^{3}} \{ ( {S}_{r 3} - {D}_{3} - {S}_{33} {θ}_{3} ) {θ}_{1} + [ {S}_{r r} + 2 ( {D}_{3} - {S}_{r 3} ) {θ}_{3} - \tilde{ϕ} + {S}_{33} {θ}_{3}^{2} ] {θ}_{1} {θ}_{3} \} \\ \frac{{\partial }^{2} {U}_{1}}{\partial {Y}^{2}} = \frac{μ}{{r}^{3}} \{ \tilde{ϕ} + [ {S}_{r r} + 2 ( {D}_{3} - {S}_{r 3} ) {θ}_{3} - \tilde{ϕ} + {S}_{33} {θ}_{3}^{2} ] {θ}_{2}^{2} \} \\ \frac{{\partial }^{2} {U}_{1}}{\partial Y \partial Z} = \frac{μ}{{r}^{3}} \{ ( {S}_{r 3} - {D}_{3} - {S}_{33} {θ}_{3} ) {θ}_{2} + [ {S}_{r r} + 2 ( {D}_{3} - {S}_{r 3} ) {θ}_{3} - \tilde{ϕ} + {S}_{33} {θ}_{3}^{2} ] {θ}_{2} {θ}_{3} \} \\ \frac{{\partial }^{2} {U}_{1}}{\partial {Z}^{2}} = \frac{μ}{{r}^{3}} \{ \tilde{ϕ} + {S}_{33} + 2 ( {S}_{r 3} - {D}_{3} - {S}_{33} {θ}_{3} ) {θ}_{3} + [ {S}_{r r} + 2 ( {D}_{3} - {S}_{r 3} ) {θ}_{3} - \tilde{ϕ} + {S}_{33} {θ}_{3}^{2} ] {θ}_{3}^{2} \}\end{matrix} ; \qquad equation ( 36 )$$

wherein, C̅₂₀ is a normalized spherical harmonic coefficient corresponding to the J₂ perturbation in an expansion of a spherical harmonic series of the earth's gravitational potential.

2. The position vector difference Δ\vec{R}_{BB*} between the target point B and the target point B* obtained by the perturbation extrapolation based on the reference solutions \vec{\dot{r}}_{A}⁰ and T⁰ in the body-fixed coordinate system is computed according to equations (37) and (38):

$$Δ {\vec{R}}_{{BB}^{*}} = {\vec{R}}_{B} - {\vec{R}}_{{B}^{*}} = [ \begin{matrix}{X}_{B} \\ {Y}_{B} \\ {Z}_{B}\end{matrix} ] - [ \begin{matrix}{X}_{{B}^{*}} \\ {Y}_{{B}^{*}} \\ {Z}_{{B}^{*}}\end{matrix} ] ; \qquad equation ( 37 )$$

wherein, the coordinate vector \vec{R}_{B*}(\vec{X}_{B*}, \vec{Y}_{B*}, \vec{Z}_{B*}) of B* in the body-fixed coordinate system is obtained from \vec{r}_{B*} through a coordinate transformation:

$${\vec{R}}_{{B}^{*}} = {M}^{T} ( {t}_{0} + {T}^{0} ) {\vec{r}}_{{B}^{*}} . \qquad equation ( 38 )$$

3. It is judged whether Δ\vec{R}_{BB*} is less than the given threshold S_{R}; if yes, the designed parameters vₚ, vᵣ, Ã, T, σ of the missile are recomputed and output based on the reference solutions and corresponding equations in steps 3 and 4, and the correction is ended; otherwise, proceeding to step 6 to perform a differential correction in order to estimate a launch velocity vector increment and a flight time increment.

Step 6: the constraint equation with the constant launch angle and a differential equation based on a position error propagation of the target point are established; the launch velocity vector increment Δ\vec{\dot{r}}_{A} and the flight time increment ΔT are computed, and corrected solutions are denoted as [symbol] and \hat{T}; the corrected solutions are taken as reference solutions for a next differential correction, that is, let: \vec{\dot{r}}_{A}⁰= [symbol] , T⁰=\hat{T}, and repeat the sub-steps of step 5.

Step 6 includes the following sub-steps:

1. A system of linear differential equations of the launch velocity vector increment Δ\vec{\dot{r}}_{A} and the flight time increment ΔT are established according to equations (39) to (41):

$$[ \begin{matrix}G & 0 \\ C & D\end{matrix} ] [ \begin{matrix}Δ {\dot{\vec{r}}}_{A} \\ Δ T\end{matrix} ] = [ \begin{matrix}0 \\ Δ {\vec{R}}_{B B} *\end{matrix} ] ; \qquad equation ( 39 )$$

wherein, Δ\vec{\dot{r}}_{A}(Δ\vec{\dot{x}}_{A}, Δ\vec{\dot{y}}_{A}, Δ\vec{ż}_{A}) and Δ\vec{R}_{BB*}(Δ\vec{x}_{BB*}, Δ\vec{y}_{BB*}, Δ\vec{z}_{BB*}) are expressed in terms of components as:

$$[ \begin{matrix}G & 0 \\ C & D\end{matrix} ] [ \begin{matrix}Δ {\dot{\vec{x}}}_{A} \\ Δ {\dot{\vec{y}}}_{A} \\ Δ {\dot{\vec{z}}}_{A} \\ Δ T\end{matrix} ] = [ \begin{matrix}0 \\ Δ {\vec{x}}_{{BB}^{*}} \\ Δ {\vec{y}}_{{BB}^{*}} \\ Δ {\vec{z}}_{{BB}^{*}}\end{matrix} ] ; \qquad equation ( 40 )$$

wherein, G is a 1×3 matrix, C is a 3×3 matrix, D is a 3×1 matrix, which are expressed as:

$$\{ \begin{matrix}G = [ - sin h cos {A}^{*} sin h sin {A}^{*} cos h ] Q W {M}^{T} ( {t}_{0} ) \\ C = {M}^{T} ( {t}_{0} + {T}^{0} ) \frac{\partial {\vec{r}}_{{B}^{*}}}{\partial {\dot{\vec{r}}}_{{A}^{*}}} \\ D = {M}^{T} ( {t}_{0} + {T}^{0} ) \frac{\partial {\vec{r}}_{{B}^{*}}}{\partial T} + {\dot{θ}}_{g} [ \begin{matrix}{Y}_{{B}^{*}} \\ - {X}_{{B}^{*}} \\ 0\end{matrix} ]\end{matrix} ; \qquad equation ( 41 )$$

wherein,

$$\frac{\partial {\vec{r}}_{{B}^{*}}}{\partial {\dot{\vec{r}}}_{A}} and \frac{\partial {\vec{r}}_{{B}^{*}}}{\partial T}$$

are computed by the numerical integration in step 5. The matrix G generates the constraint equation with the constant launch angle.

2. The system of linear differential equations are solved to obtain a set of unique solutions of Δ\vec{\dot{r}}_{A} and ΔT;

the system of linear equations (40) includes four equations and four unknown quantities so that a set of unique solutions of Δ\vec{\dot{r}}_{A} and ΔT are obtained, and then the corrected solutions [symbol] and \hat{T} are obtained according to equation (42):

$$\{ \begin{matrix}= {\dot{\vec{r}}}_{A}^{0} + Δ {\dot{\vec{r}}}_{A} \\ \hat{T} = {T}^{0} + Δ T\end{matrix} . \qquad equation ( 42 )$$

3. The corrected solutions are taken as the reference solutions for the next differential correction, that is, let \vec{\dot{r}}_{A}⁰= [symbol] , T⁰=\hat{T}, and repeat the sub-steps of step 5.

III. Results of Constructing the Trajectory

According to the method for constructing the free trajectory, when the geodetic coordinates of the launch point and the target point and the launch angle are given, the launch velocity vector and flight time of the trajectory can be derived by the two-body force model and the dynamic model including the J2 perturbation, respectively. Conversely, when the coordinates of the launch point and the launch velocity vector are known, an integration is performed over the length of the flight time by the corresponding force model. The integral of the geocentric radius vector should coincide with the coordinates of the target point, and the integral coordinates in the integration range forms the trajectory of the missile.

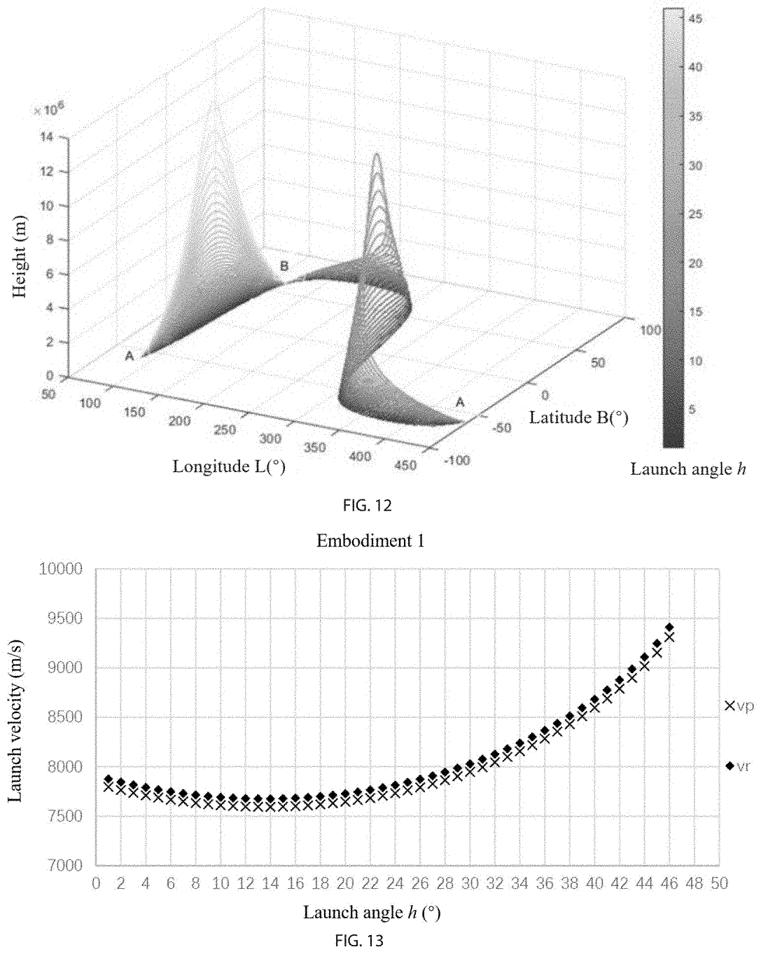

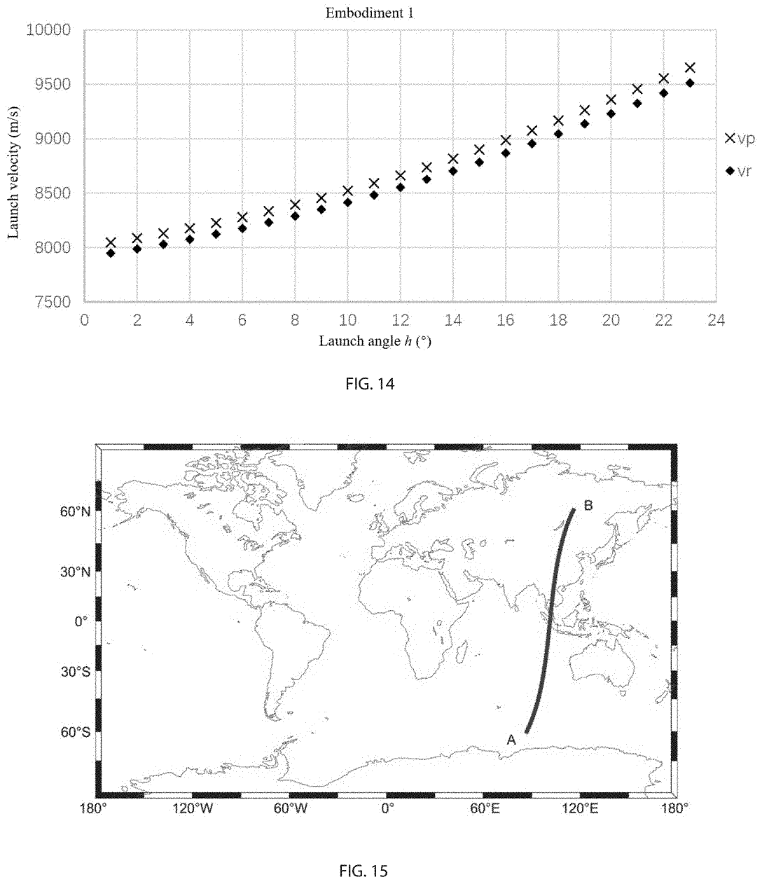

According to the known data of Embodiment 1, the launch angle is traversed from 1° by an increment of 1° to construct 46 positive-flying trajectories (at launch angle in the range of 1-46°) and 23 negative-flying trajectories (at launch angle in the range of 1-23°). If the launch angle falls outside the above ranges, then it is impossible to obtain a rationally designed trajectory. FIG. 12 illustrates all positive-flying free trajectories (left) and negative-flying free trajectories (right) constructed by the two-body force model. Different gray values represent different launch angles. The impact points of the trajectories are all converged at the target point B, so are the impact points of highly-eccentric orbits (the eccentricity of an elliptical orbit at a launch angle of 46° is 0.77), which verifies the correctness of the method for constructing the trajectory of the present invention. Each successfully constructed trajectory corresponds to a set of output parameters, including vₚ, vᵣ, Ã, T, σ. For example, when the specified launch angle is 10°, the output parameters of the positive-flying and negative-flying trajectories constructed according to Embodiment 1 are shown in Table 3. The comparison of the data in Table 3 indicates that when the launch angle is constant, the launch velocity of the negative-flying trajectory is much higher than that of the positive-flying trajectory, which is matched with the fact that a longer-range trajectory requires more launch energy. Therefore, the minimum-energy trajectory from the launch point to the target point must be a shorter-range positive-flying trajectory. By traversing the launch angle, the method for constructing the trajectory of the present invention is capable of determining not only a classic minimum-energy trajectory (with the smallest launch velocity in the inertial space) but also a practical minimum-energy trajectory (with the smallest launch velocity in the body-fixed coordinate system) among numerous successfully constructed positive-flying trajectories. FIGS. 13 and 14 respectively illustrate the functions between the launch angle and the launch velocity of the positive-flying and negative-flying trajectories constructed by means of traversing according to Embodiment 1, in which the positive-flying trajectory with the smallest launch velocity corresponding to a launch angle of 14° can be identified visibly, while the launch velocity of the negative-flying trajectory is a monotonically increasing function of the launch angle without a minimum value. When the primary concern for trajectory selection is not the minimum energy but the velocity at the impact point or the ground track, the ground track needs to be superimposed on the map data for optimization, as shown in FIG. 15, wherein the velocity at the impact point is directly proportional to the launch angle. In either case, the method for constructing the trajectory of the present invention can provide a wealth of alternative trajectories.

When the construction of the trajectories requires a precision of the order of kilometers or higher, the method for constructing the trajectory based on the two-body force model cannot meet such requirements. To this end, additional considerations must be given to the effects of perturbations such as the earth's non-central gravity, atmospheric drag and solar pressure. Having taken into account the J₂ perturbation of the earth's gravitational field, the method for precisely constructing the trajectories of the present invention only needs to append the perturbations such as the atmospheric drag and solar pressure into its framework when necessary. The ballistic parameters derived by the two-body force model, as shown in Table 3, are taken as reference solutions to perform a differential correction for the position error propagation of the target point. The J₂ perturbation is considered in the position propagation of the target point. The results of the differential correction are shown in Table 4, in which the symbol “↑” or “↓” represents an increase or decrease in the ballistic parameter after being corrected.

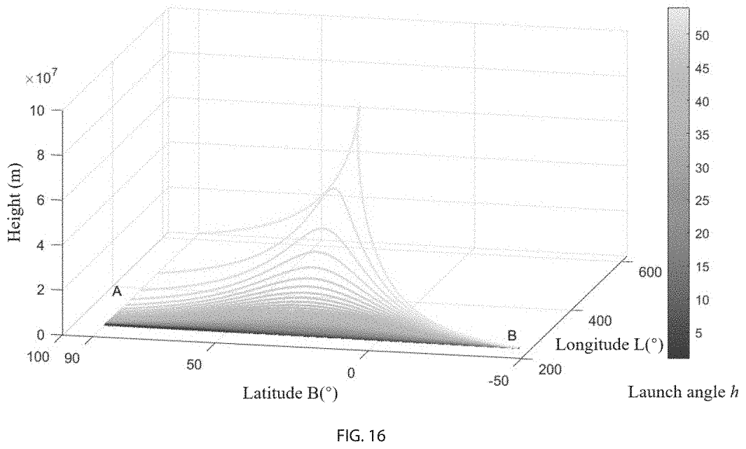

According to the known data, Embodiment 2 successfully constructs 54 positive-flying trajectories and 32 negative-flying trajectories by using the same traversal method as in Embodiment 1. FIG. 16 illustrates the 54 positive-flying trajectories. Since the launch point is located at the north pole, its longitude is indefinite and constitutes a singularity in Method 1. In this case, the method for constructing the trajectories of the present invention can still successfully construct and characterize the trajectories in the 3D rectangular coordinate system, as shown in FIG. 16, in which the launch points appear as discrete points, and the discrete points all have the latitude of 90° and thus are actually the same point in the spherical coordinate system. The above two embodiments both illustrate the feasibility and correctness of this method.

TABLE 3
Output parameters of positive-flying and negative-flying trajectories
constructed based on the two-body force model in Embodiment 1
(h = 10°; t₀ = 56163.57313347)

| | | | | | |
|---|---|---|---|---|---|
| Positive-flying | vₚ (m/s) | 7610.599 | σ | a (m) | 6026011.677 |
| | vᵣ (m/s) | 7691.680 | | i (°) | 79.4004 |
| | Ã (°) | 3.346 | | Ω (°) | 164.8504 |
| | T (min) | 35.45 | | ξ | −0.1828677 |
| | | | | η | 0.0002563 |
| | | | | λ (°) | 277.8481 |
| Negative-flying | vₚ (m/s) | 8520.429 | σ | a (m) | 7309475.919 |
| | vᵣ (m/s) | 8412.881 | | i (°) | 103.3056 |
| | Ã (°) | −167.691 | | Ω (°) | 350.2673 |
| | T (min) | 78.82 | | ξ | −0.2153108 |
| | | | | η | −0.0003193 |
| | | | | λ (°) | 223.0456 |

TABLE 4
Output parameters of positive-flying and negative-flying trajectories
constructed when the J₂ perturbation is considered in Embodiment 1
(h = 10°; t₀ = 56163.57313347)

| Positive- | vₚ | (m/s) | 7605.442 | σ | a | (m) | 6018859.853 |
|---|---|---|---|---|---|---|---|
| flying | | | ↓ 5.157 | | | | ↓ 7151.82 |
| | vᵣ | (m/s) | 7686.569 | | i | (°) | 79.3943 |
| | | | ↓ 5.111 | | | | ↓ 0.0061 |
| | Ã | (°) | 3.358 | | Ω | (°) | 164.8623 |
| | | | ↑ 0.012 | | | | ↑ 0.0119 |
| | T | (min) | 35.44 | | ξ | | −0.1832377 |
| | | | ↓ 0.01 | | | | ↓ 0.00037 |
| | | | | | η | | −0.0009288 |
| | | | | | | | ↓ 0.00119 |
| | | | | | λ | (°) | 277.8532 |
| | | | | | | | ↑ 0.0051 |
| Negative- | vₚ | (m/s) | 8517.134 | σ | a | (m) | 7302264.995 |
| flying | | | ↓ 3.295 | | | | ↓ 7210.92 |
| | vᵣ | (m/s) | 8409.680 | | i | (°) | 103.2933 |
| | | | ↓ 3.201 | | | | ↓ 0.0123 |
| | Ã | (°) | −167.718 | | Ω | (°) | 350.2419 |
| | | | ↓ 0.027 | | | | ↓ 0.0254 |
| | T | (min) | 78.95 | | ξ | | −0.2148064 |
| | | | ↑ 0.13 | | | | ↑ 0.000504 |
| | | | | | η | | −0.0010205 |
| | | | | | | | ↓ 0.0007 |
| | | | | | λ | (°) | 223.0432 |
| | | | | | | | ↓ 0.0024 |

IV. Definition of the Symbols and Variables Involved

| | Symbol | Definition | Explanation |
|---|---|---|---|
| Known | t₀ | launch epoch | |
| quantities | h | launch angle (or specified launch angle, | specified value |
| | | whose value can be specified as any real | 0 < h < 90° |
| | | number within an allowable range) | |
| | L_{A}, B_{A}, H_{A} | geodetic longitude, latitude and height of | when the point is |
| | | the launch point A | located at the north or |
| | L_{B}, B_{B}, H_{B} | geodetic longitude, latitude and height of | south pole, the |
| | | the target point B | longitude is assigned |
| | | | any value in the range |
| | | | of 0-360° |
| Constants | \vec{R}_{A}(X_{A}, Y_{A}, Z_{A}) | rectangular coordinate vector of the point A | |
| during | | in the body-fixed coordinate system | |
| iteration | \vec{R}_{B}(X_{B}, Y_{B}, Z_{B}) | rectangular coordinate vector of the point B | |
| | | in the body-fixed coordinate system | |
| | \vec{r}_{A}(x_{A}, y_{A}, z_{A}) | rectangular coordinate vector of the point A | |
| | | in the TEMEE coordinate system | |
| | ε | difference between the ratio of the modulus | |
| | | of the geocentric radius vector of the point A | |
| | | to the modulus of the geocentric radius | |
| | | vector of the point B and 1 | |
| | q | zenith angle of the target point in the | |
| | | conventional horizontal coordinate system | |
| | | of the launch point | |
| | ϕ | horizontal angle between the AB direction | |
| | | and the north-pole direction of the point A | |
| | | when the point A is not at or above the north | |
| | | or south pole | |
| | Δφ | difference between the geodetic latitude and | |
| | | the geocentric latitude of the point A | |
| Variables | T | flight time | with an initial value of |
| during | | | 0 |
| iteration | A* | launch azimuth in the target-pointing | with an initial value of |
| | | horizontal coordinate system | 0 |
| | β | half-range angle | |
| | \vec{r}_{B}(x_{B}, y_{B}, z_{B}) | rectangular coordinate vector of the point B | |
| | | in the TEMEE coordinate system | |
| | [symbol] _{A} (\dot{X}_{A}, \dot{Y}_{A}, Ż_{A}) | rectangular coordinate vector of the launch | |
| | | velocity in the body-fixed coordinate | |
| | | system | |
| | [symbol] _{A} (\dot{x}_{A}, \dot{y}_{A}, ż_{A}) | rectangular coordinate vector of the launch | |
| | | velocity in the TEMEE coordinate system | |
| | vₚ | modulus of the launch velocity vector in the | vₚ = \| [symbol] _{A}\| |
| | | body-fixed coordinate system | |
| | vᵣ | modulus of the launch velocity vector in the | vᵣ = \| [symbol] _{A}\| |
| | | TEMEE coordinate system | |
| | σ | first type of non-singular orbital elements at | 6 components, |
| | | the launch epoch | including |
| | | | a, i, Ω, ξ, η, λ |
| | ω | argument of perigee of the orbit | |
| | Δω | bias of the argument of perigee | |
| | f_{A} f_{B} | true anomalies of the points A and B on the | |
| | | elliptical trajectory/orbit | |
| | u_{A} u_{B} | true arguments of latitude of the points A | |
| | | and B on the elliptical trajectory/orbit | |
| | α | intersection angle between the launch | |
| | | velocity vector and the geocentric radius | |
| | | vector of the launch point in the body-fixed | |
| | | coordinate system | |
| | θ | intersection angle between the launch | |
| | | velocity vector and the geocentric radius | |
| | | vector of the launch point in the TEMEE | |
| | | coordinate system | |
| | [symbol] _{A*}(X*, Y*, Z*) | launch velocity vector in the target-pointing | |
| | | horizontal coordinate system | |
| | Ã | declination of the launch velocity vector in | west declination: |
| | | the target-pointing horizontal coordinate | negative; east |
| | | system relative to the target point in the | declination: positive |
| | | horizontal plane | |

| | | |
|---|---|---|
| Output | vₚ, vᵣ, Ã, T, σ | the definition of each |
| quantities | | symbol is given above |

In addition, the present invention involves the following geophysical constants: the equatorial radius of the reference ellipsoid αₑ=6378136 m, the geocentric gravitational constant μ=0.39860043770442×10¹⁵ m³/s², the oblateness of the earth f=1/298.25781, and the eccentricity of the meridian of the earth e_{c}²=2f−f²=0.0066946.

What is claimed is:

1. A method for constructing a free trajectory of a ballistic missile at a specified launch angle based on a two-body force model, comprising:
step 1: data preprocessing: sequentially computing a body-fixed rectangular coordinate vector \vec{R}_{A} of a launch point A and a body-fixed rectangular coordinate vector \vec{R}_{B} of a target point B, a difference Δ₁₀₀ between a geodetic latitude and a geocentric latitude of the launch point A, a horizontal angle ϕ between an AB direction and a north-pole direction of the launch point A in a body-fixed coordinate system, and a difference ε between a ratio of a modulus of geocentric radius vector of the launch point A to a modulus of a geocentric radius vector of the target point B and 1;
step 2: setting of an initial state of iterations: assuming that the earth does not rotate and a flight time T is zero;
step 3: computing, in the two-body force model, a launch velocity vector \vec{\dot{r}}_{A} of a positive-flying trajectory or a negative-flying trajectory in a True Equator Mean Equinox of Epoch (TEMEE) coordinate system and a launch velocity vector \vec{\dot{R}}_{A} of the positive-flying trajectory or the negative-flying trajectory in the body-fixed coordinate system, a first type of non-singular orbital elements σ of the ballistic missile at a launch epoch, and the flight time T to generate a new flight time T*; and
step 4: letting T=T*, repeating step 3 to iteratively compute the launch velocity vector \vec{\dot{r}}_{A} and the launch velocity vector \vec{\dot{R}}_{A} of the ballistic missile, the first type of non-singular orbital elements of the ballistic missile at the launch epoch, a half-range angle and the flight time until |T−T*| is less than a set threshold Sₜ to complete the iterations to finally obtain the launch velocity vector \vec{\dot{r}}_{A} and the flight time T of the ballistic missile in the two-body force model, and outputting designed parameters vₚ, vᵣ, Ã, T, σ, wherein vₚ is a modulus of the launch velocity vector in the body-fixed coordinate system, vᵣ is a modulus of the launch velocity vector in the TEMEE coordinate system, and Ã is a declination of a launch velocity vector in a target-pointing horizontal coordinate system relative to the target point B in a horizontal plane.

2. A method for constructing a free trajectory of a ballistic missile at a specified launch angle considering both a central gravity and a J₂ perturbation of the earth based on a result of a two-body force model, comprising:
step 1: data preprocessing: sequentially computing a body-fixed rectangular coordinate vector \vec{R}_{A} of a launch point A and a body-fixed rectangular coordinate vector \vec{R}_{B} of a target point B, a difference Δ_{φ} between a geodetic latitude and a geocentric latitude of the launch point A, a horizontal angle ϕ between an AB direction and a north-pole direction of the launch point A in a body-fixed coordinate system, and a difference ε between a ratio of a modulus of the geocentric radius vector of the launch point A to a modulus of the geocentric radius vector of the target point B and 1;
step 2: setting of an initial state of iterations: assuming that the earth does not rotate and a flight time T is zero;
step 3: computing, in the two-body force model, a launch velocity vector \vec{\dot{r}}_{A} of a positive-flying trajectory or a negative-flying trajectory in a True Equator Mean Equinox of Epoch (TEMEE) coordinate system and a launch velocity vector \vec{\dot{R}}_{A} of the positive-flying trajectory or the negative-flying trajectory in the body-fixed coordinate system, a first type of non-singular orbital elements σ of the ballistic missile at a launch epoch and the flight time T to generate a new flight time T*; and
step 4: letting T=T*, repeating step 3 to iteratively compute the launch velocity vector of the ballistic missile, the first type of non-singular orbital elements of the ballistic missile at the launch epoch, a half-range angle and the flight time until |T−T*| is less than a set threshold Sₜ to complete the iterations to finally obtain the launch velocity vector \vec{\dot{r}}_{A} and the flight time T of the ballistic missile in the two-body force model;
step 5: taking the launch velocity vector \vec{\dot{r}}_{A} the flight time T obtained by the two-body force model as reference solutions \vec{\dot{r}}_{A}⁰ and T⁰ for a differential correction; if a distance |Δ\vec{R}_{BB*}| between the target point B and a target point B* obtained by a perturbation extrapolation based on the reference solutions is less than a given threshold S_{R}, ending a correction of designed parameters of the ballistic missile and outputting corrected parameters vₚ, vᵣ, Ã, T, σ, wherein vₚ is a modulus of the launch velocity vector in the body-fixed coordinate system, vᵣ is a modulus of the launch velocity vector in the TEMEE coordinate system, and Ã is a declination of a launch velocity vector in a target-pointing horizontal coordinate system relative to the target point B in a horizontal plane; otherwise, proceeding to step 6; and
step 6: establishing a constraint equation with a constant launch angle and a differential equation based on a position error propagation of the target point B; computing a launch velocity vector increment Δ\vec{\dot{r}}_{A} and a flight time increment ΔT, and denoting corrected solutions as [symbol] and \hat{T}; taking the corrected solutions as reference solutions for a next differential correction by letting \vec{\dot{r}}_{A}⁰= [symbol] , T⁰=\hat{T} and repeating step 5.

3. The method according to claim 1, wherein step 1 specifically comprises:
3.1: transforming geodetic coordinates of the launch point A and the target point B from spherical coordinates (L, B, H) to 3D rectangular coordinates (X, Y, Z) according to equation (1), and expressing the 3D rectangular coordinates by \vec{R}_{A} and \vec{R}_{B} as;
$$\{ \begin{matrix}X = ( N + H ) cos B cos L \\ Y = ( N + H ) cos B sin L \\ Z = [ N ( 1 - {e}_{c}^{2} ) + H ] sin B\end{matrix} ; \qquad equation ( 1 )$$
wherein, N is a radius of curvature of a prime vertical of a point, and N=αₑ/\sqrt{1−e_{c}²(sin B)²}; αₑ is an equatorial radius; e_{c} is an eccentricity of a meridian of the earth;
3.2: computing geocentric latitudes φ_{A} and φ_{B} of the launch point A and the target point B according to equation (2):
$$φ = {sin}^{- 1} \frac{Z}{\sqrt{{X}^{2} + {Y}^{2} + {Z}^{2}}} ; \qquad equation ( 2 )$$
3.3: computing the difference Δ_{φ} between the geodetic latitude B_{A} and the geocentric latitude φ_{A} of the launch point A according to equation (3):
$$Δφ = {B}_{A} - {φ}_{A} ; \qquad equation ( 3 )$$
3.4: computing a horizontal angle ϕ between the AB direction and the north-pole direction of the launch point A in the body-fixed coordinate system according to equations (4) and (5):
$$\{ \begin{matrix}sin ϕ = \frac{cos {B}_{B} sin ( {L}_{A} - {L}_{B} )}{sin q} \\ cos ϕ = \frac{sin {B}_{B} cos {B}_{A} - cos {B}_{B} sin {B}_{A} cos ( {L}_{A} - {L}_{B} )}{sin q}\end{matrix} ; \qquad equation ( 4 )$$
wherein, B_{B} is a geodetic latitude of the target point B; L_{A}, L_{B} are geodetic longitudes of the launch point A and the target point B, respectively; q is a zenith angle of the target point B from a zenith of the launch point A, and q is computed by:
$$\{ \begin{matrix}cos q = sin {B}_{B} sin {B}_{A} + cos {B}_{B} cos {B}_{A} cos ( {L}_{A} - {L}_{B} ) \\ sin q = \sqrt{1 - {cos}^{2} q}\end{matrix} q ∈ ( 0 , π ) ; \qquad equation ( 5 )$$
when the launch point A is located at or above the north pole or the south pole, equations (4) and (5) are still satisfied, and are simplified as:
$$\{ \begin{matrix}ϕ = π - ( {L}_{A} - {L}_{B} ) & A is at or above the north pole \\ ϕ = {L}_{A} - {L}_{B} & A is at or above the south pole\end{matrix} ∀ {L}_{A} ∈ [ 0 , 360 ° ) ;$$
and
3.5: computing the difference ε between the ratio of the modulus of the geocentric radius vector of the launch point A to the modulus of the geocentric radius vector of the target point B and 1 according to equation (6):
$$ɛ = \frac{\vert {\vec{R}}_{B} \vert}{\vert {\vec{R}}_{A} \vert} - 1 . \qquad equation ( 6 )$$

4. The method according to claim 1, wherein step 3 specifically comprises:
4.1: computing coordinate vectors \vec{r}_{A} and \vec{r}_{B} of the launch point A and the target point B in the TEMEE coordinate system in combination with the flight time T according to equation (7):
$$\{ \begin{matrix}{\vec{r}}_{A} = M ( {t}_{0} ) {\vec{R}}_{A} \\ {\vec{r}}_{B} = M ( {t}_{0} + T ) {\vec{R}}_{B}\end{matrix} ; \qquad equation ( 7 )$$
wherein, t₀ is the launch epoch, and M is a transformation matrix from the body-fixed coordinate system to the TEMEE coordinate system; in a first iteration of the iterations, the flight time T is zero, and \vec{r}_{B}=M(t₀)\vec{R}_{B} is satisfied;
4.2: computing the half-range angle β according to equations (8) and (9) as follows:
a half intersection angle is expressed by:
$$δ = \frac{1}{2} \times {cos}^{- 1} \frac{{\vec{r}}_{A} \cdot {\vec{r}}_{B}}{\vert {\vec{r}}_{A} \vert \vert {\vec{r}}_{B} \vert} ; \qquad equation ( 8 )$$
then the half-range angle is computed by:
$$β = \{ \begin{matrix}δ & β ∈ ( 0 , \frac{π}{2} ) & positive - flying trajectory \\ π - δ & β ∈ ( \frac{π}{2} , π ) & negative - flying trajectory\end{matrix} ; \qquad equation ( 9 )$$
4.3: computing an inclination i and a right ascension Ω of an ascending node of an elliptical trajectory/orbit according to equation (10):
$$\{ \begin{matrix}[ \begin{matrix}sin i sin Ω \\ - sin i cos Ω \\ cos i\end{matrix} ] = \frac{{\vec{r}}_{A} \times {\vec{r}}_{B}}{\vert {\vec{r}}_{A} \times {\vec{r}}_{B} \vert} & positive - flying trajectory \\ [ \begin{matrix}sin i sin Ω \\ - sin i cos Ω \\ cos i\end{matrix} ] \frac{{\vec{r}}_{B} \times {\vec{r}}_{A}}{\vert {\vec{r}}_{B} \times {\vec{r}}_{A} \vert} & negative - flying trajectory\end{matrix} \\ i ∈ ( 0 , π ) Ω ∈ [ 0 , 2 π ) ; \qquad equation ( 10 )$$
4.4: computing true arguments of latitude μ_{A} and μ_{B} of the launch point A and the target point B on the elliptical trajectory/orbit according to equation (11):
$$\{ \begin{matrix}sin {u}_{A} = \frac{sin {φ}_{A}}{sin i} \\ cos {u}_{A} = \frac{sin {φ}_{B} - sin {φ}_{A} cos 2 β}{sin i sin 2 β} \\ {u}_{B} = {u}_{A} + 2 β\end{matrix} ; \qquad equation ( 11 )$$
4.5: computing a cosine of an angle α between the launch velocity vector and the geocentric radius vector of the launch point A in the body-fixed coordinate system according to equation (12):
$$cos α = cos Δ φsinh - sin Δ φcosh cos ( {A}^{*} - ϕ ) ; \qquad equation ( 12 )$$
wherein, h is the specified launch angle, and A*=0 in the first iteration;
4.6: computing a tangent of an angle θ between the launch velocity vector and the geocentric radius vector of the launch point A in the TEMEE coordinate system according to equation (13):
$$\{ \begin{matrix}cos θ = \frac{{v}_{P}}{{v}_{r}} cos α \\ sin θ = \sqrt{1 - {cos}^{2} θ} \\ cot θ = \frac{cos θ}{sin θ}\end{matrix} ; \qquad equation ( 13 )$$
wherein, in the first iteration,
$$\frac{{v}_{P}}{{v}_{r}} = 1 ; \qquad$$
4.7: introducing a bias Δω of an argument of perigee, computing the bias according to equation (15), and then computing the argument of perigee ω according to equation (14);
wherein, according to a nature of the elliptical trajectory/orbit of the ballistic missile, an apogee of the elliptical trajectory is located in an outer space of the earth and between the launch point A and the target point B; when the geocentric radius vector of the launch point A and the geocentric radius vector of the target point B are equal in terms of modulus, an argument of apogee is equal to a mean value of the true arguments of latitude of the launch point A and the target point B, and the mean value minus π obtains the argument of perigee ω; the argument of perigee ω computed in this way generally has a deviation due to unequal geocentric distances of the launch point A and the target point B; the bias Δω of the argument of perigee co is introduced to obtain:
$$ω = {ω}_{0} + Δω ω ∈ [ 0 , 2 π ) ; \qquad equation ( 14 )$$
wherein,
$${ω}_{0} = \frac{{u}_{A} + {u}_{B}}{2} - π ;$$
wherein μ_{A} and μ_{B} have been computed according to equation (11); Δω is computed according to equation (15);
$$tan Δ ω = \frac{ɛ}{2 ( 1 + ɛ ) cot θ - ɛ cot β} Δω ∈ [ - \frac{π}{2} , \frac{π}{2} ] ; \qquad equation ( 15 )$$
accordingly, true anomalies of the launch point A and the target point B on the elliptical trajectory/orbit are expressed by the bias Δω as follows:
$$\{ \begin{matrix}{f}_{A} = π - β - Δ ω \\ {f}_{B} = π + β - Δ ω\end{matrix} ; \qquad equation ( 16 )$$
4.8: computing an eccentricity e of the elliptical trajectory/orbit according to equation (17):
$$e = \frac{cot θ}{sin ( β + Δ ω ) + cot θ cos ( β + Δ ω )} ; \qquad equation ( 17 )$$
4.9: rationality judgement of the specified launch angle h: if any one of the following conditions is satisfied, then judging the specified launch angle to be irrational, a rationally designed trajectory is not obtained, ending a current construction procedure of the free trajectory, and re-specifying a launch angle;
for the positive-flying trajectory:
(1) if e≥1, then judging the specified launch angle to be excessively large;
(2) if cot θ≤0 or |tan Δω|≥tan β, then judging the specified launch angle to be excessively small;
for the negative-flying trajectory:
$$if e \geq 1 or cot θ \geq - tan β + \frac{ɛ}{2 ( 1 + ɛ )} ( tan β + cot β ) , \qquad ( 1 )$$
then judging the specified launch angle to be excessively large;
$$if cot θ \leq max \{ \frac{ɛ}{2 ( 1 + ɛ )} cot β , 0 \} , \qquad ( 2 )$$
then judging the specified launch angle to be excessively small;
4.10: computing the true anomalies f_{A} and f_{B} of the launch point A and the target point B on the elliptical trajectory/orbit according to equation (16);
4.11: computing the first type of non-singular orbital elements σ of the ballistic missile at the launch epoch according to equations (18) to (21);
wherein, σ is a set of the first type of non-singular orbital elements, wherein the inclination i and the right ascension Ω of the ascending node of the elliptical orbit are computed according to equation (10), and a semi-major axis α and ξ, η, λ are computed as follows:
$$\begin{matrix}a = \frac{\vert {\vec{r}}_{A} \vert [ 1 - e cos ( β + Δω ) ]}{1 - {e}^{2}} ; & equation ( 18 ) \\ \{ \begin{matrix}ξ = e cos ω \\ η = - e sin ω \\ λ = ω + {M}_{A}\end{matrix} ; & equation ( 19 )\end{matrix}$$
M_{A} is computed as follows:
$$\begin{matrix}\{ \begin{matrix}{E}_{A} = {f}_{A} - 2 {tan}^{- 1} ( \frac{e sin {f}_{A}}{1 + \sqrt{1 - {e}^{2}} + e cos {f}_{A}} ) \\ {E}_{B} = {f}_{B} - 2 {tan}^{- 1} ( \frac{e sin {f}_{B}}{1 + \sqrt{1 - {e}^{2}} + e cos {f}_{B}} )\end{matrix} ; & equation ( 20 ) \\ \{ \begin{matrix}{M}_{A} = {E}_{A} - e sin {E}_{A} \\ {M}_{B} = {E}_{B} - e sin {E}_{B}\end{matrix} ; & equation ( 21 )\end{matrix}$$
4.12: computing the flight time T* of the ballistic missile according to equation (22):
$$\{ \begin{matrix}{T}^{*} = \frac{{M}_{B} - {M}_{A}}{n} \\ n = \sqrt{μ / {a}^{3}}\end{matrix} ; \qquad equation ( 22 )$$
wherein, μ is a geocentric gravitational constant;
4.13: computing the modulus vᵣ of the launch velocity vector of the ballistic missile in the TEMEE coordinate system and the modulus vₚ of the launch velocity vector of the ballistic missile in the body-fixed coordinate system according to equations (23) to (25):
wherein, the launch velocity vectors \vec{\dot{r}}_{A} and \vec{\dot{R}}_{A} of the ballistic missile in the TEMEE coordinate system and the body-fixed coordinate system satisfy:
$$\begin{matrix}\{ \begin{matrix}{\dot{\vec{r}}}_{A} = \sqrt{\frac{μ}{ρ}} [ ( - sin {u}_{A} + η ) \vec{P} + ( cos {u}_{A} + ξ ) \vec{Q} ] \\ \vec{P} = [ \begin{matrix}cos Ω \\ sin Ω \\ 0\end{matrix} ] \\ \vec{Q} = [ \begin{matrix}- sin Ω cos i \\ cos Ω cos i \\ sin i\end{matrix} ] \\ p = a ( 1 - {e}^{2} )\end{matrix} ; & equation ( 23 ) \\ {\dot{\vec{R}}}_{A} = M ( {t}_{0} ) {\dot{\vec{r}}}_{A} - {\dot{θ}}_{g} [ \begin{matrix}- {Y}_{A} \\ {X}_{A} \\ 0\end{matrix} ] ; & equation ( 24 )\end{matrix}$$
wherein \vec{R}_{A}(X_{A}, Y_{A}, Z_{A}) is a rectangular coordinate vector of the launch point A in the body-fixed coordinate system;
then:
$$\{ \begin{matrix}{v}_{p} = \vert {\dot{\vec{R}}}_{A} \vert \\ {v}_{r} = \vert {\dot{\vec{r}}}_{A} \vert\end{matrix} ; \qquad equation ( 25 )$$
wherein, \dot{θ}_{g} is a change rate of a Greenwich sidereal hour angle in the TEMEE coordinate system and is 360°.985612288/day;
4.14: computing a launch azimuth A* in a target-pointing horizontal coordinate system according to equations (26) and (27) as follows:
denoting a launch velocity vector in the target-pointing horizontal coordinate system as \vec{\dot{R}}_{A*}(X*, Y*, Z*) derived by performing a coordinate rotation on \vec{\dot{R}}_{A} as follows:
$$\begin{matrix}{\dot{\vec{R}}}_{{A}^{*}} = QW {\dot{\vec{R}}}_{A} ; & equation ( 26 ) \\ [ \begin{matrix}{X}^{*} \\ {Y}^{*} \\ {Z}^{*}\end{matrix} ] = \vert {\dot{\vec{R}}}_{{A}^{*}} \vert [ \begin{matrix}cos h cos {A}^{*} \\ - cos h sin {A}^{*} \\ sin h\end{matrix} ] ; & equation ( 27 )\end{matrix}$$
wherein, W is a rotation matrix from the body-fixed coordinate system to a conventional horizontal coordinate system, and Q is a rotation matrix from the conventional horizontal coordinate system to the target-pointing horizontal coordinate system.

5. The method according to claim 1, wherein step 4 specifically comprises:
5.1: judging whether |T−T*|<Sₜ is satisfied; if yes, letting T=T*, and proceeding to a next step; otherwise, letting T=T*, and returning to step 3;
5.2: computing the declination Ã of the launch velocity vector in the target-pointing horizontal coordinate system relative to the target point B in the horizontal plane according to equation (28):
$$\{ \begin{matrix}\tilde{A} = {A}^{*} & {A}^{*} \leq π \\ \tilde{A} = {A}^{*} - 2 π & {A}^{*} > π\end{matrix} ; \qquad equation ( 28 )$$
5.3: outputting the designed parameters vₚ, vᵣ, Ã, T, σ of the ballistic missile.

6. The method according to claim 2, wherein step 5 specifically comprises:
6.1: denoting the target point obtained by the perturbation extrapolation based on the reference solutions \vec{\dot{r}}_{A}⁰ and T⁰ as B*, and computing partial derivative matrices
$$\frac{\partial {\vec{r}}_{{B}^{*}}}{\partial {\dot{\vec{r}}}_{A}} , \frac{\partial {\vec{r}}_{{B}^{*}}}{\partial T}$$
and a position vector \vec{r}_{B*} of B* in the TEMEE coordinate system by a numerical integration;
performing the numerical integration by a Gragg-Bulirsch-Stoer first-order integrator to adapt to computing highly-eccentric trajectories, wherein differential equations to be integrated are:
$$\{ \begin{matrix}\frac{d \vec{r}}{d t} = \vec{v} \\ \frac{d \vec{v}}{d t} = \vec{F} ( \vec{r} ) \\ \frac{d}{d t} ( \frac{\partial \vec{r}}{\partial {\dot{\vec{r}}}_{A}} ) = \frac{\partial \vec{v}}{\partial {\dot{\vec{r}}}_{A}} \\ \frac{d}{d t} ( \frac{\partial \vec{v}}{\partial {\dot{\vec{r}}}_{A}} ) = \frac{\partial \vec{F}}{\partial \vec{ r}} \cdot \frac{\partial \vec{r}}{\partial {\dot{\vec{r}}}_{A}}\end{matrix} ; \qquad equation ( 29 )$$
wherein, \vec{v}, \vec{r} represent a velocity vector and a position vector, respectively;
deriving initial values as:
$$\{ \begin{matrix}\vec{r} ( {t}_{0} ) = {\vec{r}}_{A} \\ \vec{v} ( {t}_{0} ) = {{\dot{\vec{r}}}_{A}}^{0} \\ \frac{\partial \vec{r}}{\partial {\dot{\vec{r}}}_{A}} {\vert}_{t = {t}_{0}} = 0 \\ \frac{\partial \vec{v}}{\partial {\dot{\vec{r}}}_{A}} {\vert}_{t = {t}_{0}} = I\end{matrix} ; \qquad equation ( 30 )$$
integrating from t=t₀ to t=t₀+T⁰ to obtain:
$$\{ \begin{matrix}{\vec{r}}_{{B}^{*}} = \vec{r} {\vert}_{t = {t}_{0} + {T}^{0}} \\ \frac{\partial {\vec{r}}_{{B}^{*}}}{\partial T} = \vec{ν} {\vert}_{t = {t}_{0} + {T}^{0}} \\ \frac{\partial {\vec{r}}_{{B}^{*}}}{\partial {\dot{\vec{r}}}_{A}} = \frac{\partial \vec{r}}{\partial {\dot{\vec{r}}}_{A}} {\vert}_{t = {t}_{0} + {T}^{0}}\end{matrix} ; \qquad equation ( 31 )$$
expressing a force function \vec{F}(\vec{r}) only comprising the J₂ perturbation and a partial derivative matrix
$$\frac{\partial \vec{F}}{\partial \vec{r}}$$
of the force function \vec{F}(\vec{r}) in equation (29) as:
$$\{ \begin{matrix}\vec{F} = {( ∇ U )}_{r} = M ( t ) \cdot {( ∇ U )}_{R} \\ \frac{\partial \vec{F}}{\partial \vec{r}} = {( {∇}^{2} U )}_{r} = M ( t ) \cdot {( {∇}^{2} U )}_{R} \cdot {M}^{T} ( t )\end{matrix} ; \qquad equation ( 32 )$$
wherein, t is an integration time; subscripts r and R represent a gradient or a tensor of U in the TEMEE coordinate system and the body-fixed coordinate system, respectively; U represents a gravitational potential function of the earth in the body-fixed coordinate system and U comprises a central gravitational potential U₀ and a J₂ gravitational potential U₁:
$$U = {U}_{0} + {U}_{1} ; \qquad equation ( 33 )$$
accordingly, the gradient and the tensor of the gravitational potential function U of the earth are obtained as follows:
$$\{ \begin{matrix}{( ∇ U )}_{R} = {( ∇ {U}_{0} )}_{R} + {( ∇ {U}_{1} )}_{R} \\ {( {∇}^{2} U )}_{R} = {( {∇}^{2} {U}_{0} )}_{R} + {( {∇}^{2} {U}_{1} )}_{R}\end{matrix} ; \qquad equation ( 34 )$$
wherein,
$$\{ \begin{matrix}{( ∇ {U}_{0} )}_{R} = - \frac{μ}{{r}^{3}} {( X , Y , Z )}^{T} \\ {( {∇}^{2} {U}_{0} )}_{R} = \frac{μ}{{r}^{3}} [ \begin{matrix}- 1 + 3 \frac{{X}^{2}}{{r}^{2}} & \frac{3 X Y}{{r}^{2}} & \frac{3 X Z}{{r}^{2}} \\ \frac{3 X Y}{{r}^{2}} & - 1 + 3 \frac{{Y}^{2}}{{r}^{2}} & \frac{3 Y Z}{{r}^{2}} \\ \frac{3 X Z}{{r}^{2}} & \frac{3 Y Z}{{r}^{2}} & 1 + 3 \frac{{Z}^{2}}{{r}^{2}}\end{matrix} ] \\ {( ∇ {U}_{1} )}_{R} = {( \frac{\partial {U}_{1}}{\partial X} , \frac{\partial {U}_{1}}{\partial Y} , \frac{\partial {U}_{1}}{\partial Z} )}^{T} \\ {( {∇}^{2} {U}_{1} )}_{R} = [ \begin{matrix}\frac{{\partial }^{2} {U}_{1}}{\partial {X}^{2}} & \frac{{\partial }^{2} {U}_{1}}{\partial X \partial Y} & \frac{{\partial }^{2} {U}_{1}}{\partial X \partial Z} \\ \frac{{\partial }^{2} {U}_{1}}{\partial X \partial Y} & \frac{{\partial }^{2} {U}_{1}}{\partial {Y}^{2}} & \frac{{\partial }^{2} {U}_{1}}{\partial X \partial Z} \\ \frac{{\partial }^{2} {U}_{1}}{\partial Z \partial X} & \frac{{\partial }^{2} {U}_{1}}{\partial Z \partial Y} & \frac{{\partial }^{2} {U}_{1}}{\partial {Z}^{2}}\end{matrix} ]\end{matrix} ; \qquad equation ( 35 )$$
wherein, (X, Y, Z)^{T} is a three-dimensional (3D) rectangular coordinate vector of the ballistic missile in the body-fixed coordinate system, and r=R=\sqrt{X²+Y²+Z²}; elements composing matrices or vectors in equation (35) are expressed by:
$$\begin{matrix}\{ \begin{matrix}letting {θ}_{1} = \frac{X}{r} ; {θ}_{2} = \frac{Y}{r} ; {θ}_{3} = \frac{Z}{r} = ζ \\ \begin{matrix}{\overline{P}}_{2} ( ζ ) = \sqrt{5} \times \frac{( 3 {ζ}^{2} - 1 )}{2} ; {\overline{P}}_{2}^{′} ( ζ ) = 3 \sqrt{5} ζ ; \\ {\overline{P}}_{2}^{″} ( ζ ) = 3 \sqrt{5}\end{matrix} \\ \begin{matrix}{D}_{r} = - 3 {{\overline{C}}_{20} ( \frac{{a}_{e}}{r} )}^{2} {\overline{P}}_{2} ( ζ ) ; \\ {D}_{3} = {{\overline{C}}_{20} ( \frac{{a}_{e}}{r} )}^{2} {\overline{P}}_{2}^{′} ( ζ )\end{matrix} \\ \begin{matrix}{S}_{r r} = 12 {{\overline{C}}_{20} ( \frac{{a}_{e}}{r} )}^{2} {\overline{P}}_{2} ( ζ ) ; {S}_{r 3} = - 3 {{\overline{C}}_{20} ( \frac{{a}_{e}}{r} )}^{2} {\overline{P}}_{2}^{′} ( ζ ) ; \\ {S}_{33} = {{\overline{C}}_{20} ( \frac{{a}_{e}}{r} )}^{2} {\overline{P}}_{2}^{″} ( ζ )\end{matrix} \\ \tilde{ϕ} = {D}_{r} - {D}_{3} {θ}_{3} \\ \begin{matrix}\frac{\partial {U}_{1}}{\partial X} = \frac{μ}{{r}^{2}} \tilde{ϕ} {θ}_{1} ; \frac{\partial {U}_{1}}{\partial Y} = \frac{μ}{{r}^{2}} \tilde{ϕ} {θ}_{2} ; \\ \frac{\partial {U}_{1}}{\partial Z} = \frac{μ}{{r}^{2}} ( {D}_{3} + \tilde{ϕ} {θ}_{3} )\end{matrix} \\ \begin{matrix}\frac{{\partial }^{2} {U}_{1}}{\partial {X}^{2}} = \frac{μ}{{r}^{3}} \{ \tilde{ϕ} + [ {S}_{r r} + 2 ( {D}_{3} - {S}_{r 3} ) \\ {θ}_{3} - \tilde{ϕ} + {S}_{33} {{θ}_{3}}^{2} ] {{θ}_{1}}^{2} \}\end{matrix} \\ \begin{matrix}\frac{{\partial }^{2} {U}_{1}}{\partial X \partial Y} = \frac{μ}{{r}^{3}} [ {S}_{r r} + 2 ( {D}_{3} - {S}_{r 3} ) \\ {θ}_{3} - \tilde{ϕ} + {S}_{33} {{θ}_{3}}^{2} ] {θ}_{1} {θ}_{2}\end{matrix} \\ \begin{matrix}\frac{{\partial }^{2} {U}_{1}}{\partial X \partial Z} = \frac{μ}{{r}^{3}} \{ ( {S}_{r 3} - {D}_{3} - {S}_{33} {θ}_{3} ) {θ}_{1} + \\ [ {S}_{r r} + 2 ( {D}_{3} - {S}_{r3} ) {θ}_{3} - \tilde{ϕ} + {S}_{33} {{θ}_{3}}^{2} ] {θ}_{1} {θ}_{3} \}\end{matrix} \\ \begin{matrix}\frac{{\partial }^{2} {U}_{1}}{\partial {Y}^{2}} = \frac{μ}{{r}^{3}} \{ \tilde{ϕ} + [ {S}_{r r} + 2 ( {D}_{3} - {S}_{r3} ) \\ {θ}_{3} - \tilde{ϕ} + {S}_{33} {{θ}_{3}}^{2} ] {{θ}_{2}}^{2} \}\end{matrix} \\ \begin{matrix}\frac{{\partial }^{2} {U}_{1}}{\partial Y \partial Z} = \frac{μ}{{r}^{3}} \{ ( {S}_{r 3} - {D}_{3} - {S}_{33} {θ}_{3} ) {θ}_{2} + \\ [ {S}_{r r} + 2 ( {D}_{3} - {S}_{r 3} ) {θ}_{3} - \tilde{ϕ} + {S}_{33} {{θ}_{3}}^{2} ] {θ}_{2} {θ}_{3} \}\end{matrix} \\ \begin{matrix}\frac{{\partial }^{2} {U}_{1}}{\partial {Z}^{2}} = \frac{μ}{{r}^{3}} \{ \tilde{ϕ} + {S}_{33} + 2 ( {S}_{r 3} - {D}_{3} - {S}_{33} {θ}_{3} ) {θ}_{3} + \\ [ {S}_{rr} + 2 ( {D}_{3} - {S}_{r 3} ) {θ}_{3} - \tilde{ϕ} + {S}_{33} {{θ}_{3}}^{2} ] {{θ}_{3}}^{2} \}\end{matrix}\end{matrix} ; & \end{matrix} \qquad equation ( 36 )$$
wherein, C̅₂₀ is a normalized spherical harmonic coefficient corresponding to the J₂ perturbation in an expansion of a spherical harmonic series of the gravitational potential function of the earth;
6.2: computing a position vector difference Δ\vec{R}_{BB*} between the target point B and the target point B* obtained by the perturbation extrapolation based on the reference solutions \vec{\dot{r}}_{A}⁰ and T⁰ in the body-fixed coordinate system according to equations (37) and (38):
$$Δ {\vec{R}}_{B {B}^{*}} = {\vec{R}}_{B} - {\vec{R}}_{{B}^{*}} = [ \begin{matrix}{X}_{B} \\ {Y}_{B} \\ {Z}_{B}\end{matrix} ] - [ \begin{matrix}{X}_{{B}^{*}} \\ {Y}_{{B}^{*}} \\ {Z}_{{B}^{*}}\end{matrix} ] ; \qquad equation ( 37 )$$
wherein, \vec{R}_{B}(X_{B}, Y_{B}, Z_{B}) is a rectangular coordinate vector of the target point B in the body-fixed coordinate system; a coordinate vector \vec{R}_{B*}(\vec{X}_{B*}, \vec{Y}_{B*}, \vec{Z}_{B*}) of B* in the body-fixed coordinate system is obtained from \vec{r}_{B*} through a coordinate transformation:
$${\vec{R}}_{{B}^{*}} = {M}^{T} ( {t}_{0} + {T}^{0} ) {\vec{r}}_{{B}^{*}} ; \qquad equation ( 38 )$$
6.3: judging whether Δ\vec{R}_{BB*} is less than a given threshold S_{R}; if yes, recomputing and outputting the designed parameters vₚ, vᵣ, Ã, T, σ of the ballistic missile based on the reference solutions and steps 3 and 4, and ending the correction; otherwise, proceeding to step 6 to perform the differential correction to estimate the launch velocity vector increment and the flight time increment.

7. The method according to claim 2, wherein step 6 specifically comprises:
7.1: establishing a system of linear differential equations of the launch velocity vector increment Δ\vec{\dot{r}}_{A} and the flight time increment ΔT according to equations (39) to (41):
$$[ \begin{matrix}G & & 0 \\ C & & D\end{matrix} ] [ \begin{matrix}Δ {\dot{\vec{r}}}_{A} \\ Δ T\end{matrix} ] = [ \begin{matrix}0 \\ Δ {\vec{R}}_{{BB}^{*}}\end{matrix} ] ; \qquad equation ( 39 )$$
expressing Δ\vec{\dot{r}}_{A}(Δ\vec{\dot{x}}_{A}, Δ\vec{\dot{y}}_{A}, Δ\vec{ż}_{A}) and Δ\vec{R}_{BB*}(Δ\vec{x}_{BB*}, Δ\vec{y}_{BB*}, Δ\vec{z}_{BB*}) in equation (39) in terms of components as:
$$[ \begin{matrix}G & & 0 \\ C & & D\end{matrix} ] [ \begin{matrix}Δ {\dot{\vec{x}}}_{A} \\ Δ {\dot{\vec{y}}}_{A} \\ Δ {{z}^{\dot{\to }}}_{A} \\ Δ T\end{matrix} ] = [ \begin{matrix}0 \\ Δ {\vec{x}}_{{BB}^{*}} \\ Δ {\vec{y}}_{{BB}^{*}} \\ Δ {\vec{z}}_{{BB}^{*}}\end{matrix} ] ; \qquad equation ( 40 )$$
wherein, G is a 1×3 matrix, C is a 3×3 matrix, D is a 3×1 matrix, and G, C and D are expressed as:
$$\{ \begin{matrix}G = [ sin h cos {A}^{*} sin h sin {A}^{*} cos h ] Q W {M}^{T} ( {t}_{0} ) \\ C = {M}^{T} ( {t}_{0} + {T}^{0} ) \frac{\partial {\vec{r}}_{B} *}{\partial {{r}^{\dot{\to }}}_{A}} \\ D = {M}^{T} ( {t}_{0} + {T}^{0} ) \frac{\partial {\tilde{r}}_{{B}^{*}}}{\partial T} + {\dot{θ}}_{g} [ \begin{matrix}{Y}_{{B}^{*}} \\ - {X}_{{B}^{*}} \\ 0\end{matrix} ]\end{matrix} ; \qquad equation ( 41 )$$
wherein,
$$\frac{\partial {\tilde{r}}_{{B}^{*}}}{\partial {{r}^{\dot{\to }}}_{A}} and \frac{\partial {\vec{r}}_{{B}^{*}}}{\partial T}$$
are computed by a numerical integration in step 5; the matrix G generates the constraint equation with the constant launch angle;
7.2: solving the system of linear differential equations to obtain a set of unique solutions of Δ\vec{\dot{r}}_{A} and ΔT;
wherein the system of linear differential equations comprise four equations and four unknown quantities, the set of unique solutions of Δ\vec{\dot{r}}_{A} and ΔT are obtained, and then the corrected solutions [symbol] and \hat{T} are obtained according to equation (42);
$$\{ \begin{matrix}\hat{{\dot{\vec{r}}}_{A}} = {\dot{\vec{r}}}_{A}^{0} + Δ {\dot{\vec{r}}}_{A} \\ \hat{T} = {T}^{0} + Δ T\end{matrix} ; \qquad equation ( 42 )$$
7.3: taking the corrected solutions as the reference solutions for the next differential correction by letting \vec{\dot{r}}_{A}⁰= [symbol] , T⁰=\hat{T}, and repeating step 5.

8. The method according to claim 2, wherein step 1 specifically comprises:
3.1: transforming geodetic coordinates of the launch point A and the target point B from spherical coordinates (L, B, H) to 3D rectangular coordinates (X, Y, Z) according to equation (1), and expressing the 3D rectangular coordinates by \vec{R}_{A} and \vec{R}_{B} as;
$$\{ \begin{matrix}X = ( N + H ) cos B cos L \\ Y = ( N + H ) cos B sin L \\ Z = [ N ( 1 - {e}_{c}^{2} ) + H ] sin B\end{matrix} ; \qquad equation ( 1 )$$
wherein, N is a radius of curvature of a prime vertical of a point, and N=αₑ/\sqrt{1−e_{c}²(sin B)²}; αₑ is an equatorial radius; e_{c} is an eccentricity of a meridian of the earth;
3.2: computing geocentric latitudes φ_{A} and φ_{B} of the launch point A and the target point B according to equation (2):
$$φ = {sin}^{- 1} \frac{Z}{\sqrt{{X}^{2} + {Y}^{2} + {Z}^{2}}} ; \qquad equation ( 2 )$$
3.3: computing the difference Δ_{φ} between the geodetic latitude B_{A} and the geocentric latitude φ_{A} of the launch point A according to equation (3):
$$Δφ = {B}_{A} - {φ}_{A} ; \qquad equation ( 3 )$$
3.4: computing a horizontal angle ϕ between the AB direction and the north-pole direction of the launch point A in the body-fixed coordinate system according to equations (4) and (5):
$$\{ \begin{matrix}sin ϕ = \frac{cos {B}_{B} sin ( {L}_{A} - {L}_{B} )}{sin q} \\ cos ϕ = \frac{sin {B}_{B} cos {B}_{A} - cos {B}_{B} sin {B}_{A} cos ( {L}_{A} - {L}_{B} )}{sin q}\end{matrix} ; \qquad equation ( 4 )$$
wherein, B_{B} is a geodetic latitude of the target point B; L_{A}, L_{B} are geodetic longitudes of the launch point A and the target point B, respectively; q is a zenith angle of the target point B from a zenith of the launch point A, and q is computed by:
$$\{ \begin{matrix}cos q = sin {B}_{B} sin {B}_{A} + cos {B}_{B} cos {B}_{A} cos ( {L}_{A} - {L}_{B} ) \\ sin q = \sqrt{1 - {cos}^{2} q}\end{matrix} q ∈ ( 0 , π ) ; \qquad equation ( 5 )$$
when the launch point A is located at or above the north pole or the south pole, equations (4) and (5) are still satisfied, and are simplified as:
$$\{ \begin{matrix}ϕ = π - ( {L}_{A} - {L}_{B} ) & A is at or above the north pole \\ ϕ = {L}_{A} - {L}_{B} & A is at or above the south pole\end{matrix} ∀ {L}_{A} ∈ [ 0 , 360 ° ) ;$$
and
3.5: computing the difference ε between the ratio of the modulus of the geocentric radius vector of the launch point A to the modulus of the geocentric radius vector of the target point B and 1 according to equation (6):
$$ɛ = \frac{\vert {\vec{R}}_{B} \vert}{\vert {\vec{R}}_{A} \vert} - 1 . \qquad equation ( 6 )$$

9. The method according to claim 2, wherein step 3 specifically comprises:
4.1: computing coordinate vectors \vec{r}_{A} and \vec{r}_{B} of the launch point A and the target point B in the TEMEE coordinate system in combination with the flight time T according to equation (7):
$$\{ \begin{matrix}{\vec{r}}_{A} = M ( {t}_{0} ) {\vec{R}}_{A} \\ {\vec{r}}_{B} = M ( {t}_{0} + T ) {\vec{R}}_{B}\end{matrix} ; \qquad equation ( 7 )$$
wherein, t₀ is the launch epoch, and M is a transformation matrix from the body-fixed coordinate system to the TEMEE coordinate system; in a first iteration of the iterations, the flight time T is zero, and \vec{r}_{B}=M(t₀)\vec{R}_{B} is satisfied;
4.2: computing the half-range angle β according to equations (8) and (9) as follows:
a half intersection angle is expressed by:
$$δ = \frac{1}{2} \times {cos}^{- 1} \frac{{\vec{r}}_{A} \cdot {\vec{r}}_{B}}{\vert {\vec{r}}_{A} \vert \vert {\vec{r}}_{B} \vert} ; \qquad equation ( 8 )$$
then the half-range angle is computed by:
$$β = \{ \begin{matrix}δ & β ∈ ( 0 , \frac{π}{2} ) & positive - flying trajectory \\ π - δ & β ∈ ( \frac{π}{2} , π ) & negative - flying trajectory\end{matrix} ; \qquad equation ( 9 )$$
4.3: computing an inclination i and a right ascension Ω of an ascending node of an elliptical trajectory/orbit according to equation (10):
$$\{ \begin{matrix}[ \begin{matrix}sin i sin Ω \\ - sin i cos Ω \\ cos i\end{matrix} ] = \frac{{\vec{r}}_{A} \times {\vec{r}}_{B}}{\vert {\vec{r}}_{A} \times {\vec{r}}_{B} \vert} & positive - flying trajectory \\ [ \begin{matrix}sin i sin Ω \\ - sin i cos Ω \\ cos i\end{matrix} ] = \frac{{\vec{r}}_{B} \times {\vec{r}}_{A}}{\vert {\vec{r}}_{B} \times {\vec{r}}_{A} \vert} & negative - flying trajectory\end{matrix} \\ i ∈ ( 0 , π ) Ω ∈ [ 0 , 2 π ) ; \qquad equation ( 10 )$$
4.4: computing true arguments of latitude μ_{A} and μ_{B} of the launch point A and the target point B on the elliptical trajectory/orbit according to equation (11):
$$\{ \begin{matrix}sin {u}_{A} = \frac{sin {φ}_{A}}{sin i} \\ cos {u}_{A} = \frac{sin {φ}_{B} - sin {φ}_{A} cos 2 β}{sin i sin 2 β} \\ {u}_{B} = {u}_{A} + 2 β\end{matrix} ; \qquad equation ( 11 )$$
4.5: computing a cosine of an angle α between the launch velocity vector and the geocentric radius vector of the launch point A in the body-fixed coordinate system according to equation (12):
$$cos α = cos Δφsin h - sin Δφcos h cos ( {A}^{*} - ϕ ) ; \qquad equation ( 12 )$$
wherein, h is the specified launch angle, and A*=0 in the first iteration;
4.6: computing a tangent of an angle θ between the launch velocity vector and the geocentric radius vector of the launch point A in the TEMEE coordinate system according to equation (13):
$$\{ \begin{matrix}cos θ = \frac{{v}_{P}}{{v}_{r}} cos α \\ sin θ = \sqrt{1 - {cos}^{2} θ} \\ cot θ = \frac{cos θ}{sin θ}\end{matrix} ; \qquad equation ( 13 )$$
wherein, in the first iteration,
$$\frac{{v}_{p}}{{ν}_{r}} = 1 ;$$
4.7: introducing a bias Δω of an argument of perigee, computing the bias according to equation (15), and then computing the argument of perigee ω according to equation (14);
wherein, according to a nature of the elliptical trajectory/orbit of the ballistic missile, an apogee of the elliptical trajectory is located in an outer space of the earth and between the launch point A and the target point B; when the geocentric radius vector of the launch point A and the geocentric radius vector of the target point B are equal in terms of modulus, an argument of apogee is equal to a mean value of the true arguments of latitude of the launch point A and the target point B, and the mean value minus π obtains the argument of perigee ω; the argument of perigee ω computed in this way generally has a deviation due to unequal geocentric distances of the launch point A and the target point B; the bias Δω of the argument of perigee ω is introduced to obtain:
$$ω = {ω}_{0} + Δω \\ ω ∈ [ 0 , 2 π ) ; \qquad equation ( 14 )$$
wherein,
$${ω}_{0} = \frac{{u}_{A} + {u}_{B}}{2} - π ;$$
wherein μ_{A} and μ_{B} have been computed according to equation (11); Δω is computed according to equation (15);
$$tan Δ ω = \frac{ɛ}{2 ( 1 + ɛ ) cot θ - ɛ cot β} \\ Δω ∈ [ - \frac{π}{2} , \frac{π}{2} ] ; \qquad equation ( 15 )$$
accordingly, true anomalies of the launch point A and the target point B on the elliptical trajectory/orbit are expressed by the bias Δω as follows:
$$\{ \begin{matrix}{f}_{A} = π - β - Δ ω \\ {f}_{B} = π + β - Δ ω\end{matrix} ; \qquad equation ( 16 )$$
4.8: computing an eccentricity e of the elliptical trajectory/orbit according to equation (17):
$$e = \frac{cot θ}{sin ( β + Δ ω ) + cot θ cos ( β + Δ ω )} ; \qquad equation ( 17 )$$
4.9: rationality judgement of the specified launch angle h: if any one of the following conditions is satisfied, then judging the specified launch angle to be irrational, a rationally designed trajectory is not obtained, ending a current construction procedure of the free trajectory, and re-specifying a launch angle;
for the positive-flying trajectory:
(1) if e≥1, then judging the specified launch angle to be excessively large;
(2) if θ≤0 or |tan Δω|≥tan β, then judging the specified launch angle to be excessively small;
for the negative-flying trajectory:
$$if e \geq 1 or cot θ \geq - tan β + \frac{ɛ}{2 ( 1 + ɛ )} ( tan β + cot β ) , \qquad ( 1 )$$
then judging the specified launch angle to be excessively large;
$$if cot θ \leq max \{ \frac{ɛ}{2 ( 1 + ɛ )} cot β , 0 \} , \qquad ( 2 )$$
then judging the specified launch angle to be excessively small;
4.10: computing the true anomalies f_{A} and f_{B} of the launch point A and the target point B on the elliptical trajectory/orbit according to equation (16);
4.11: computing the first type of non-singular orbital elements σ of the ballistic missile at the launch epoch according to equations (18) to (21);
wherein, σ is a set of the first type of non-singular orbital elements, wherein the inclination i and the right ascension Ω of the ascending node of the elliptical orbit are computed according to equation (10), and a semi-major axis α and ξ, η, λ are computed as follows:
$$\begin{matrix}a = \frac{\vert {\vec{r}}_{A} \vert [ 1 - e cos ( β + Δ ω ) ]}{1 - {e}^{2}} ; & equation ( 18 ) \\ \{ \begin{matrix}ξ = e cos ω \\ η = - e sin ω \\ λ = ω + {M}_{A}\end{matrix} ; & equation ( 19 )\end{matrix}$$
M_{A} is computed as follows:
$$\begin{matrix}\{ \begin{matrix}{E}_{A} = {f}_{A} - 2 {tan}^{- 1} ( \frac{e sin {f}_{A}}{1 + \sqrt{1 - {e}^{2}} + e cos {f}_{A}} ) \\ {E}_{B} = {f}_{B} - 2 {tan}^{- 1} ( \frac{e sin {f}_{B}}{1 + \sqrt{1 - {e}^{2}} + e cos {f}_{B}} )\end{matrix} ; & equation ( 20 ) \\ \{ \begin{matrix}{M}_{A} = {E}_{A} - e sin {E}_{A} \\ {M}_{B} = {E}_{B} - e sin {E}_{B}\end{matrix} ; & equa t ion ( 21 )\end{matrix}$$
4.12: computing the flight time T* of the ballistic missile according to equation (22):
$$\{ \begin{matrix}{T}^{*} = \frac{{M}_{B} - {M}_{A}}{n} \\ n = \sqrt{μ / {a}^{3}}\end{matrix} ; \qquad equation ( 22 )$$
wherein, μ is a geocentric gravitational constant;
4.13: computing the modulus vᵣ of the launch velocity vector of the ballistic missile in the TEMEE coordinate system and the modulus vₚ of the launch velocity vector of the ballistic missile in the body-fixed coordinate system according to equations (23) to (25):
wherein, the launch velocity vectors \vec{\dot{r}}_{A} and \vec{\dot{R}}_{A} of the ballistic missile in the TEMEE coordinate system and the body-fixed coordinate system satisfy:
$$\begin{matrix}\{ \begin{matrix}{\dot{\vec{r}}}_{A} = \sqrt{\frac{μ}{p}} [ ( - sin {u}_{A} + η ) \vec{P} + ( cos {u}_{A} + ξ ) \vec{Q} ] \\ \vec{P} = [ \begin{matrix}cos Ω \\ sin Ω \\ sin i\end{matrix} ] \\ \vec{Q} = [ \begin{matrix}- sin Ω cos i \\ cos Ωcos i \\ sin i\end{matrix} ] \\ p = a ( 1 - {e}^{2} )\end{matrix} ; & equation ( 23 ) \\ {\dot{\vec{R}}}_{A} = M ( {t}_{0} ) {\dot{\vec{r}}}_{A} - {\dot{θ}}_{g} [ \begin{matrix}- {Y}_{A} \\ {X}_{A} \\ 0\end{matrix} ] ; & equation ( 24 )\end{matrix}$$
wherein, \vec{R}_{A}(X_{A}, Y_{A}, Z_{A}) is a rectangular coordinate vector of the launch point A in the body-fixed coordinate system;
then:
$$\{ \begin{matrix}{v}_{p} = \vert {\dot{\vec{R}}}_{A} \vert \\ {ν}_{r} = \vert {\dot{\vec{r}}}_{A} \vert\end{matrix} ; \qquad equation ( 25 )$$
wherein, \dot{θ}_{g} is a change rate of a Greenwich sidereal hour angle in the TEMEE coordinate system and is 360°.985612288/day;
4.14: computing a launch azimuth A* in a target-pointing horizontal coordinate system according to equations (26) and (27) as follows:
denoting a launch velocity vector in the target-pointing horizontal coordinate system as \vec{\dot{R}}_{A*}(X*, Y*, Z*) derived by performing a coordinate rotation on \vec{\dot{R}}_{A} as follows:
$$\begin{matrix}{{R}^{\dot{\to }}}_{{A}^{*}} = QW {\dot{\vec{R}}}_{A} ; & equation ( 26 ) \\ [ \begin{matrix}{X}^{*} \\ {Y}^{*} \\ {Z}^{*}\end{matrix} ] = \vert {{R}^{\dot{\to }}}_{{A}^{*}} \vert [ \begin{matrix}cos h cos {A}^{*} \\ - cos h sin {A}^{*} \\ sin h\end{matrix} ] ; & equation ( 27 )\end{matrix}$$
wherein, W is a rotation matrix from the body-fixed coordinate system to a conventional horizontal coordinate system, and Q is a rotation matrix from the conventional horizontal coordinate system to the target-pointing horizontal coordinate system.

10. The method according to claim 2, wherein step 4 specifically comprises:
5.1: judging whether |T−T*|<Sₜ is satisfied; if yes, letting T=T*, and proceeding to a next step; otherwise, letting T=T*, and returning to step 3;
5.2: computing the declination Ã of the launch velocity vector in the target-pointing horizontal coordinate system relative to the target point B in the horizontal plane according to equation (28):
$$\{ \begin{matrix}\tilde{A} = {A}^{*} & {A}^{*} \leq π \\ \tilde{A} = {A}^{*} - 2 π & {A}^{*} > π\end{matrix} ; \qquad equation ( 28 )$$
5.3: outputting the designed parameters vₚ, vᵣ, Ã, T, σ of the ballistic missile.
